(19) United States
(12) Patent Application Publication
(10) Pub. No.: US 2025/0112881 A1
(43) Pub. Date: Apr. 3, 2025

(54) OPTIMIZATIONS FOR NON-BLOCKING MESSAGES

(71) Applicant: REFINITIV US ORGANIZATION LLC, New York, NY (US)

(72) Inventor: Hayden MELTON, Philadelphia, PA (US)

(21) Appl. No.: 18/979,955

(22) Filed: Dec. 13, 2024

Related U.S. Application Data
(63) Continuation-in-part of application No. 17/886,676, filed on Aug. 12, 2022.
(60) Provisional application No. 63/233,038, filed on Aug. 13, 2021.
(60) Provisional application No. 63/237,651, filed on Aug. 27, 2021.
(60) Provisional application No. 63/610,386, filed on Dec. 14, 2023.

(51) Int. Cl. H04L 51/212; H04L 47/12

(52) U.S. Cl. CPC H04L 51/212; H04L 47/12

(57) ABSTRACT

A system may access a first message for processing over the electronic communication network, the first message being associated with at least two potentially conflicting message states. The system may generate, based on the first message, a phantom message for transmission to a message receiver, the phantom message indicating the two potentially conflicting message states. The system may transmit the phantom message to the message receiver and to a data distributor that provides data updates regarding messages to one or more participants. The data distributor may not provide a data update for phantom messages. The system may access a second message that would otherwise block the phantom message until a response is received from the message receiver regarding a processing result for the phantom message. The system may generate a non-blocking message based on the second message, and transmit the non-blocking message to the message receiver and the data distributor.

### RELATED APPLICATIONS

This application is a continuation-in-part of U.S. patent application Ser. No. 17/886,676, filed on Aug. 12, 2022, entitled “Pipelined Credit Checking,” which claims priority to U.S. Provisional Patent Application No. 63/233,038, filed Aug. 13, 2021, entitled “Pipelined Credit Checking,” and U.S. Provisional Patent Application No. 63/237,651, filed Aug. 27, 2021, entitled “Deterministic Credit System,” the contents of each of which are incorporated by reference in their entireties herein. This application also claims priority to U.S. Provisional Patent Application Ser. No. 63/610,386, filed on Dec. 14, 2023, entitled, “TECHNIQUES AND OPTIMIZATIONS FOR PIPELINED CREDIT CHECKING,” which is incorporated by reference in its entirety herein.

### BACKGROUND

When communicating data between devices in an electronic communication network, oftentimes it is necessary for a message transmitter to wait for a response from a message receiver before another message is sent. For example, the message transmitter may transmit a message that represents a request to a message receiver. In this example, the message transmitter may have to wait for a response from the message receiver. Such wait may be necessary because the response may completely resolve the original request such that no new messaging is required. In another example, the response may only partially resolve the original request and require another message to request resolution of the remaining portions of the original request. In yet another example, the response may not resolve any portion of the original request, requiring another message that requests completion of the original request. Such messaging may be referred to herein as blocking because subsequent messages are blocked from generation and/or transmission pending the receipt of responses to prior messages.

Blocking messaging may cause latency issues, particularly when a number of cycles of message transmission, response receipt, and new message generation is necessary. Furthermore, blocking messaging may impose higher loads on computer infrastructure because of the serial nature of computing and transmitting messages, responses, and new messages (and responses to those new messages). These and other issues may exist in systems that use blocking messaging.

### SUMMARY

The disclosure relates to systems, methods, and computer-readable media for non-blocking messaging in an electronic communication network. The term non-blocking may refer to the generation and/or transmission of a message through an electronic communication network without having to wait for a response from a message receiver.

In non-blocking messaging, a message transmitter may generate messages and transmit the messages to a message receiver without waiting for responses from the message receiver. The message receiver may incorporate some or all of the logic from the message transmitter to at least partially process the messages in the same way as the message transmitter, to at least partly facilitating non-blocking messaging. To further facilitate non-blocking messaging, the message receiver may generate and update a cache for the messages. The cache may maintain a state of the content of the messages so that the message receiver may continue to receive messages from the message transmitter in a non-blocking manner. In some examples, the cache may be a hash that maps parties associated with the messages to maintain a state of the data relating to the parties. Thus, the cache may be a hashmap cache that maintains a state of the data from the messages. In some examples, the parties may each be identified by respective identifiers, in which case the hashmap cache may be keyed based on a pair of the identifiers. The hashmap cache may facilitate rapid indexing of the data in the messages and maintenance of the state of the data, which may in turn facilitate non-blocking messaging disclosed herein.

Because the non-blocking messaging may result in a stream of messages, some of the messages may relate to one another while other ones of the messages do not. Thus, the message receiver may perform a lookup of related messages in the cache (such as via the index) and evaluate related ones of the messages based on the logic of the message transmitter, logic of the message receiver, and the cache.

Non-blocking messaging may be implemented in various contexts in which a message transmitter must otherwise wait for a response from a message receiver. In the context of an electronic trading venue, an example of a message transmitter is a matching engine and an example of a message receiver is a credit engine. In an ordinary blocking scheme, the matching engine receives orders from market participants and identifies price-compatible orders that are contra to one another (such as a taker order and a contra-order that are price-compatible to one another). The matching engine may then ordinarily transmit the order and the contra-order to a credit engine to ensure that the parties that submitted the order and the contra-order have sufficient bilateral credit with one another.

The credit engine may determine whether the parties have extended appropriate bilateral credit to complete the order and contra-order and transmit a response back to the matching engine. If there is sufficient bilateral credit, the order is completed. If there is no bilateral credit, then the matching engine will identify a new potential match and submit that potential match to the credit engine. Thus, order matching by the matching engine and the requisite bilateral credit checking by the credit engine will ordinarily require blocking messaging, which causes latency and computational load in matching and completing orders.

In non-blocking messaging, the matching engine may identify price compatible orders and contra-orders. Rather than wait for credit checking, the matching engine may forward the messages containing orders from market participants to the credit engine in a non-blocking manner. That is, messages conveying the orders and contra-orders may be transmitted to the credit engine in real-time without waiting for credit checking responses. The credit engine may receive the messages and store them in a cache, which may be a hashmap cache. The hashmap cache may be used to update a state of the cached orders. The credit engine may look up orders in the cache and use match rules ordinarily used by the matching engine to match the cached orders as well as perform credit checking on the orders. The credit engine may generate a result of such lookup, matching and credit checking to the matching engine, which may update its limit order books. Through these and other improvements, the ETV may implement non-blocking messaging, which may reduce latency and enhance throughput for processing orders.

### BRIEF DESCRIPTION OF THE DRAWINGS

Features of the present disclosure may be illustrated by way of example and not limited in the following Figure(s), in which like numerals indicate like elements, in which:

FIG. 1A illustrates a schematic example of blocking messaging in which generation and/or transmission of a message is blocked until a response to a prior message has been received;

FIG. 1B illustrates a schematic example of non-blocking messaging in which generation and/or transmission of a message is not blocked, reducing bandwidth usage and improving speed;

FIG. 2 illustrates an example of a computer system of an electronic trading venue that implements non-blocking messaging in an electronic communication network;

FIG. 3 illustrates an example of a method of matching by a matching engine of the ETV in conjunction with the credit engine;

FIG. 4 illustrates an example of a method for processing by the matching engine a result of a credit engine of the electronic trading venue;

FIG. 5 illustrates an example of a method for processing by the credit engine a non-blocking message from the matching engine;

FIG. 6 illustrates an example of a method of non-blocking messaging to reduce congestion and execution time in an electronic communication network;

FIG. 7 illustrates an example of a method of an electronic trading venue that implements non-blocking messaging to reduce congestion and execution time in an electronic communication network;

FIG. 8 illustrates an example of a method for generating credit request and initial assignment of temporal ID's upon receipt of a taker order;

FIG. 9 illustrates an example of a method for processing request received from the matching engine;

FIG. 10 illustrates an example of a method for processing a response received from the credit engine;

FIG. 11 illustrates an example of a method of simulated matching for the pair of taker order and maker limit order book;

FIG. 12 illustrates an example of a method for processing a case in which a taker has multiple taker orders in the same request;

FIG. 13 illustrates an example of a method for skipping subsequent orders from a given maker after an initial credit check failure between that maker and taker during an instance of either matching or credit screening;

FIG. 14 illustrates an example of a method for piggybacking canceled order information in credit request at the matching engine, so successfully canceled orders can be purged from the credit engine's cache;

FIG. 15 illustrates an example of a method for designating phantom orders;

FIG. 16 illustrates an example of a method for removing designation of an order as ‘phantom’, according to an implementation;

FIG. 17 illustrates an example of a method for excluding ‘cancel requested’ orders from credit requests and for adding the credit request id to the relevant order's unacks set before the request is sent;

FIG. 18 illustrates an example of a method for removing from the relevant orders unack sets the credit request id upon receipt of its response, and for handling orders that are completely filled and ones that have ‘cancel requested’ upon receipt of that response;

FIG. 19 illustrates an example of a method for maintaining its credit cache upon receipt of a credit request from the matching engine;

FIG. 20 illustrates an example of a method for non-blocking phantom message;

FIG. 21 illustrates an example of a method for pruning messages prior to transmission; and

FIG. 22 illustrates an example of a computer system that may be implemented by the features illustrated in FIG. 1 or 2.

### DETAILED DESCRIPTION

Systems and methods are disclosed to provide non-blocking messaging in an electronic communication network. A message may refer to data that is communicated over an electronic communication network. Blocked messaging is used in various contexts whenever the generation or transmission of a subsequent message is based on a response from a receiver to a prior message. However, because of the nature of blocked messaging, computer systems and networks may suffer from latency from the waiting and throughput problems because of the repeated message-and-response that may occur.

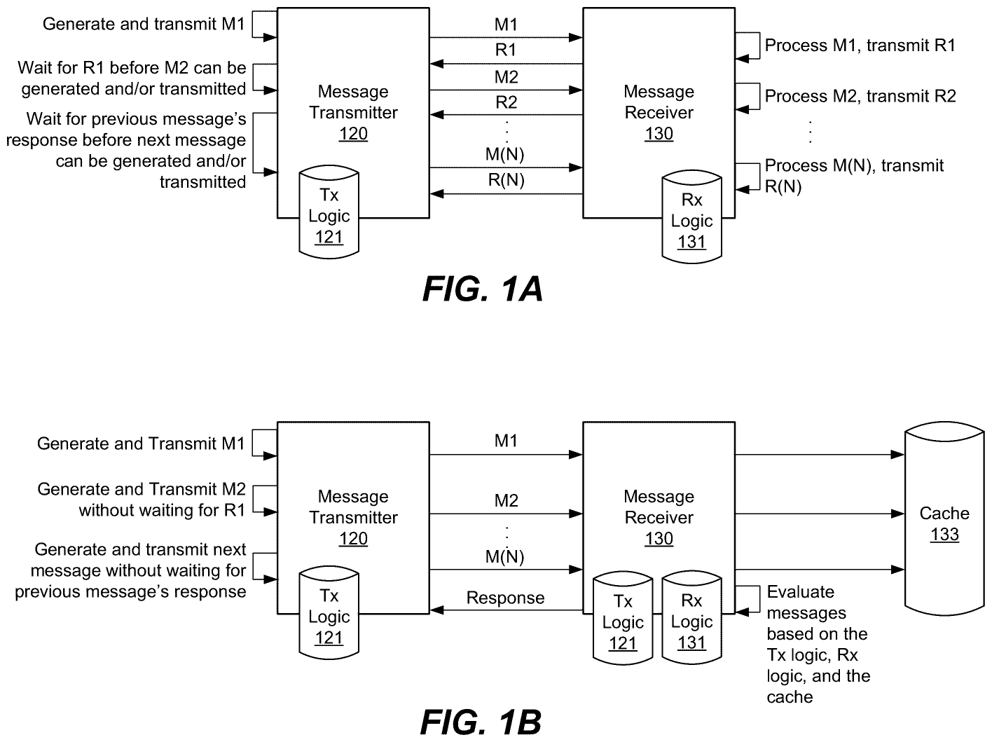

For example, FIG. 1A illustrates a schematic example of blocked messaging in which generation and/or transmission of a message is blocked until a response to a prior message has been received. Blocked messaging may arise when a message transmitter 120 uses transmitter logic (Tx logic) 121 in the generation of messages (M1-M(N)) and relies on a message receiver 130 that uses receiver logic (Rx logic) 131 to provide a result of processing the messages.

For example, the message transmitter 120 may use Tx logic 121 to generate a message M1 and transmit the message M1 to the message receiver 130. The message receiver 130 may apply Rx logic 131 to process the message M1 and generate a result of processing the message M1. The message receiver 130 may then transmit back a response R1 that indicates the result. In some examples, the response R1 may complete the exchange of data required between the message transmitter 120 and the message receiver 130, in which case no further messaging relating to M1 is required between the message transmitter 120 and the message receiver 130. In other instances, the response R1 does not complete the exchange of data required, in which case the message transmitter 120 may apply Tx logic 121 to generate a new message M2 for transmission to the message receiver 130. Thus, whether or not the message M2 needs to be generated may be based on the response R1. Furthermore, in some instances, the generation of message M2 is based on the content of the response R1. For example, not only is the necessity of the message M2 contingent upon the content of response R1, the content of message M2 may be based on the content of response R1. Because the necessity and/or content of the message M2 is based on the content of response R1, the message M2 is referred to as being blocked. The foregoing blocked messaging may continue until the data exchange relating to the message M1 is complete.

As can be seen in the above, blocked messaging may lead to network latency because the message transmitter 120 has to wait for the response from the message receiver 130 before determining whether the exchange of data is complete or whether further exchanges are necessary. If further exchanges are necessary, such further exchange is subject to more waiting, further exacerbating latency and computational load in computing Tx logic 121 and Rx logic 131. Other issues may arise out of blocked messaging as well.

To address the foregoing and other issues, non-blocking messaging may improve the performance of systems such as the message transmitter 120 and/or the message receiver 130, as well as the electronic communication network. For example, FIG. 1B illustrates a schematic example of non-blocking messaging in which generation and/or transmission of a message is not blocked, reducing bandwidth usage and improving speed, among other improvements.

In non-blocking messaging, the message transmitter 120 may apply Tx logic 121 to generate messages M1-M(N) and transmit the messages without waiting for responses from the message receiver 130. The message receiver 130 may incorporate some or all of the Tx logic 121 to at least partially process the messages M1-M(N) in the same way as the message transmitter 120, enabling the message transmitter 120 to offload at least some of its functionality on the message receiver 130 to at least partly facilitate non-blocking messaging. The message receiver 130 may generate and update a cache 133 for the messages M1-M(N). The cache 133 may maintain a state of the content of the messages M1-M(N). In some examples, the cache 133 may be a hash that maps parties associated with the messages M1-M(N) to maintain a state of the data relating to the parties. Thus, the cache 133 may be a hashmap cache that maintains a state of the data from the messages M1-M(N). In some examples, the parties may each be identified by respective identifiers, in which case the hashmap cache may be keyed based on a pair of the identifiers. The hashmap cache may facilitate rapid indexing of the data in the messages M1-M(N) and maintenance of the state of the data, which may in turn facilitate non-blocking messaging disclosed herein.

Because the non-blocking messaging may result in a stream of messages M1-M(N), some of the messages M1-M(N) may relate to one another while other ones of the messages M1-M(N) do not. Thus, the message receiver 130 may perform a lookup of related messages M1-M(N) in the cache 133 (such as via the index) and evaluate related ones of the messages M1-M(N) based on the Tx logic 121, Rx logic 131, and the cache 133. Referring to both FIGS. 1A and 1B, it should be noted that the transmitter 120 may also receive data (such as responses R1-R(N)). Similarly, the receiver 130 may also transmit data (such as responses R1-R(N)).

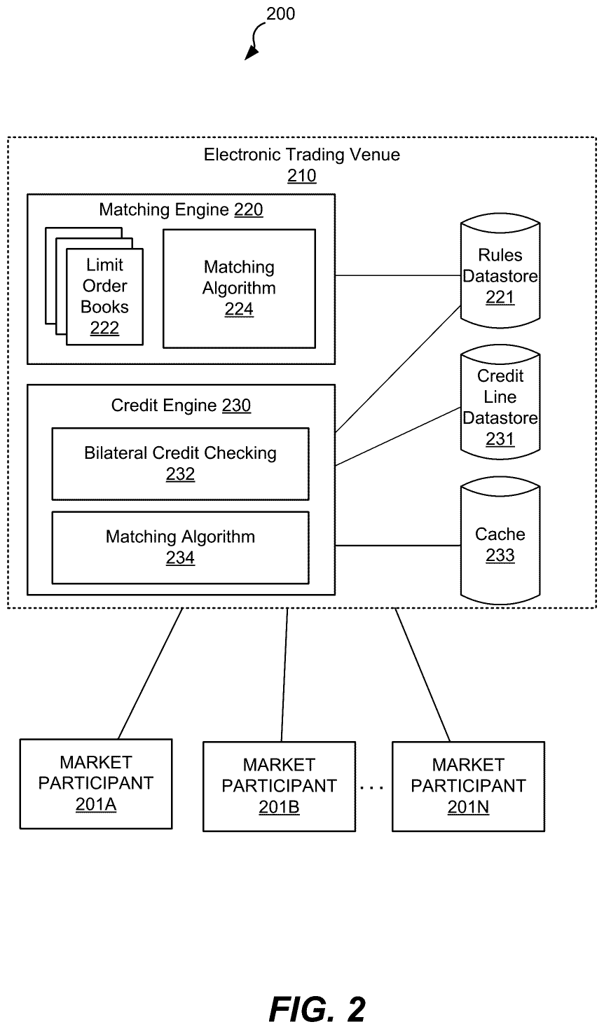

Having described an overview of blocking and non-blocking messaging, attention will now turn to an example of a system that is improved by applying non-blocking messaging for further illustration. For example, FIG. 2 illustrates an example of a system 200 of an electronic trading venue (“ETV”) 210 that implements non-blocking messaging in an electronic communication network.

Financial instruments that are traded on electronic trading venues (ETVs) may be centrally or bilaterally cleared. In the case of bilateral clearing a credit relationship must exist between the two counterparties for a trade to occur between them. On ETVs implementing pre-trade anonymity among participants it is the ETV that must decide when price-compatible contra-orders for an instrument are eligible to form a trade. The component of the ETV that is typically responsible for doing this is often referred to as the credit engine. On conventional ETVs hosting instruments that trade on the basis of bilateral credit trades are initially formed inside the matching engine component using attributes of orders such as price, side and time, and those partially formed trades are subsequently sent with counterparty information to the credit engine for credit checking. If credit checking succeeds the trade is completed; if not it has failed and the trade is unwound. This conventional approach to trade formation is shown diagrammatically in FIG. 1.

What may further characterize conventional trade formation in bilaterally cleared ETVs is the division of responsibility among the components shown in FIG. 2. Ordinarily, the matching engine may be responsible for performing operations on orders (managing their states in terms of their open/filled quantities, replenishing their visible quantities from their reserve quantities if advanced order types such as icebergs are supported, rejecting or accepting cancel/cancel-replace requests, and so forth), whereas the credit engine may be responsible for performing operations on partially formed trades.

Such a division of responsibility may be advantageous for an ETV implemented as a software product line (e.g., where both central clearing and bilateral trading are supported), and for software engineering activities such as testing, maintenance, division of labor, and so on.

Conventional approaches to credit checking on ETVs with bilateral credit, however, suffer a number of drawbacks. One such drawback manifests when the credit check fails between the counterparties and the (partially formed) trade needs to be unwound. In this scenario if the matching engine strictly respects price-time priority for passive orders the credit-checking operation may need to block so other passive orders with lower time or price priority on the instrument cannot trade while a trade involving a passive order having higher priority is in-flight between the matching engine and credit engine components, or is being processed by the credit engine component. Such blocking operations are detrimental to the throughput/performance of the matching engine and in turn to that of the ETV overall.

If, on the other hand, the matching engine does not strictly respect price-time priority (e.g., by performing a non-blocking credit check) then additional drawbacks may manifest upon failure of a credit check. Chief among these may be having to explain to a market participant why trades occurred on lower priority passive orders while theirs was in-flight as a partially formed trade but ultimately failed.

Further drawbacks may present themselves as technical complications if in a conventional ETV the credit-check is non-blocking. These include whether to remove the order from the book and publish it in market data at the time of the partially formed trade, or to delay its removal and publish market data only after a response is received by the matching engine from the credit engine; whether or not to reposition or cancel an order that has failed a credit check; whether or not to perform further round-trips between the matching engine and credit engine to ‘bust’ subsequent trades and retry on the initial failed trade with subsequent taker orders in an attempt to restore price-time priority, and so on. Besides the additional software engineering effort required to address these technical complications-both for the ETV operator, and to the extent any such complication becomes externally observable for market participants too—many may also be detrimental to the ETV's throughput, response time and performance, generally.

The ETV 210 may include a matching engine 220, which is an example of the message transmitter 120 illustrated in FIGS. 1A and 1B, and a credit engine 230, which is an example of the message receiver 130 illustrated in FIGS. 1A and 1B. In this example, the exchange logic in the rules datastore 221 is an example of Tx logic 121 used by the transmitter 120 in FIGS. 1A and 1B to generate messages. The credit line datastore 231 may store credit line relationships among participants 101. The credit line datastore 231 and logic of the bilateral credit checking 232 at the credit engine 230 is an example of the Rx logic 131 used by the message receiver 130 in FIGS. 1A and 1B.

The ETV 210 may receive orders from market participants 201A-N. For example, each market participant 101 may send orders to the ETV 210, receive messages responsive to those orders, receive market data updates from the ETV 210, and/or otherwise interact with the ETV 210. The infrastructure between the market participants 201 and matching engine 220 of the ETV 210 (such as object gateways and market data distributors are well-known and therefore omitted from FIG. 2 for clarity). The term “market participant” (or simply “participant”) is intended to be broadly construed to refer to any entity that receives (through a computing device) market data from the venue, or sends (through a computing device) object-related messages to the venue, including, but not limited to: a firm that conducts business on the electronic trading venue, a credit entity associated with such a firm (a single firm may have a plurality of credit entities), or a user (human or otherwise).

Orders from market participants 201 may be processed by the matching engine 220, which may host limit object books 222 for various instruments for which the orders relate. Each order may correspond to an order to be matched at the ETV 210 with other orders. The matching engine 220 may use default exchange logic, which may be encoded in the rules datastore 221 to match a given order with other orders in the limit object books 222. For example, an order may be a taker order that takes a contra-order such as a maker object in a limit object book 222. Other types of orders may be matched against a limit order book 222.

In particular, the matching engine 220 may use the matching algorithm 224 to determine whether two contra objects are eligible to match with one another by ensuring the orders are price-compatible and on contra-sides. When the matching engine 220 pairs orders based on price-compatibility and being on contra-sides, the ETV 210 still needs to validate the pair by ensuring that participants 201 that submitted the orders have sufficient bilateral credit between them to complete the paired orders. If no bilateral credit exists at all between the participants 201, then the entire pair must be abandoned and the matching engine 220 may seek a new pair to fulfill the orders. If some, but insufficient, bilateral credit exists between the participants 201, then only part of the paired orders will be matched up to the bilateral credit that exists between the participants, and the matching engine 220 may seek addition pairs of orders that are price compatible and contra-sides to one another to fill the remaining portion of the order.

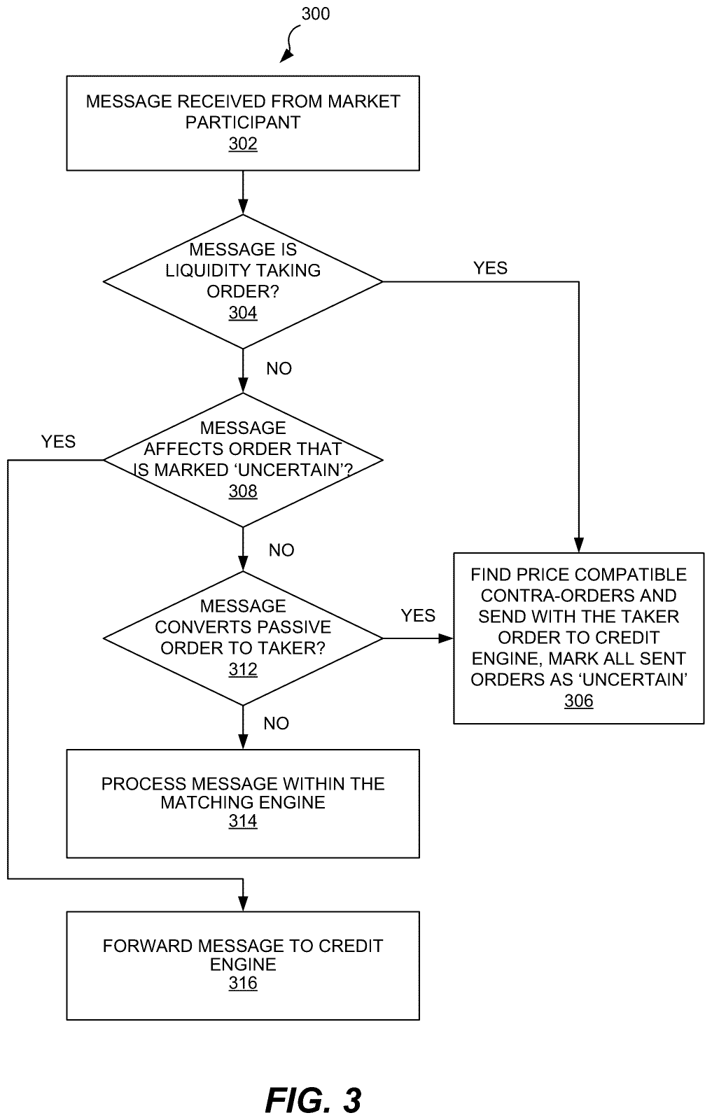

To perform bilateral credit checking, the matching engine 220 may consult a credit engine 230. Ordinarily, such bilateral credit checking is necessarily performed in a blocked messaging manner to satisfy price-time or other rules. An example of blocked messaging (illustrated in FIG. 1A) used by the ETV 210 will be described to illustrate the latency, throughput, and other issues that such blocked messaging causes in the context of orders processed by an electronic trading venue and transmitted through an electronic communication network. This example will be followed by an examples in which non-blocking messaging (illustrated in FIG. 1B) is implemented by the ETV 210, including a discussion with respect to FIGS. 3-7.

### Blocked Messaging of the ETV 210

The matching engine 220 may generate a message to the credit engine 230 that requests whether the participants 201 that submitted price-compatible and contra-orders (such as a taker and maker orders) have sufficient bilateral credit to complete the match. If so, the ETV 210 may update the credit line datastore 231 to ‘drawdown’ the credit lines between the two participants' lines in the amount of the match. If not, the matching engine 220 may find other price compatible contra-orders to partially or completely fill an order. Because the ETV 210 must comply with price-time rules to ensure fairness, and because the credit engine 230 has access to the bilateral credit lines between participants 201, the matching engine 220 ordinarily must submit a first pair of orders to the credit engine 230 and wait for a response from the credit engine 230 to determine whether there is sufficient bilateral credit between the participants 201 before the next-in-line price compatible contra order should be matched with an order to complete the order.

### Non-Blocking Messaging of the ETV 210

The ETV 210 may be improved to implement a non-blocking approach to credit checking that imposes some responsibility for state management of orders and implementation of matching rules (which are examples of Tx logic 121 in FIGS. 1A and 1B) from the rules datastore 221 onto the credit engine 230. Such non-blocking messaging used in the ETV 210 may be referred to herein as “pipelined credit checking.” In examples of non-blocking messaging, the matching engine 220 may send groups of price-compatible contra-orders to the credit engine 230. Upon receiving those orders the credit engine 230 may determine which can match, based on credit and the matching rules. Since the credit engine 230 will typically receive from the matching engine 220 all contra-orders that could match (such as all passive orders that are price-compatible with the taker) along with the corresponding taker order, the credit engine 230 may perform a matching function across multiple orders substantially all-at-once. This can ensure that price-time rules (and/or other rules the ETV 210 may implement for matching such as for visible and hidden portions of an iceberg, and its replenishment) are never violated, even when a credit check fails. Advantageously under pipelined credit checking this can happen (i) without blocking at the matching engine 220, and (ii) without multiple roundtrips of messaging between the matching engine and credit engine in the case of a credit failure. The credit engine 230 then sends completed trades and orders with updated attributes back to the matching engine 220.

The non-blocking nature of pipelined credit checking may require state management of orders within the credit engine 230. The same passive orders may be sent in duplicate (or triplicate or more, across multiple requests) to the credit engine 230 if two or more competing taker orders are received by the matching engine in quick succession. To avoid ‘overfills’ on such orders the credit engine 230 may maintain state for orders it has received in the cache 233. The cache 233 may store the state of orders, such as whether and the extent to which filled. The cache 233 may be implemented as a hashmap cache containing the most recent versions of such orders.

To illustrate, assuming two taker orders received in quick succession are both price compatible only with the same (single) passive order, if the first taker order completely fills the open quantity of the passive order then irrespective of credit no quantity remains for the second taker order to match with. If the taker orders are received in very close temporal proximity then only the credit engine 230, and not the matching engine 220, knows with certainty that the maker order was filled. Thus, the credit engine 230 must do some state management on the orders it receives.

In some examples of pipelined credit checking, the matching engine 220 may operate in an unmodified manner with respect to orders it is “certain” about. The matching engine 220 is “uncertain” about an order if and only if that order is the subject of a pending request to the credit engine 230. Specifically, by virtue of the request being pending, the matching engine 220 does not know if the order will be completely filled, partially filled, canceled or will remain unchanged. Put another way, if there are no pending requests on an order (i.e., requests to the credit engine for which the matching engine has not received a corresponding response) then the matching engine 220 can be certain about the state of that order and can process it itself independently of the credit engine 230—a cancel request, cancel-replace request or amendment of that order can thus be processed by the matching engine 220 in an unmodified manner.

In some examples of pipelined credit checking, the matching engine 220 may forward cancel requests, cancel-amendments and/or amendments on uncertain orders to the credit engine. This may ensure those requests do not themselves cause blocking in the matching engine 220 and may allow additional flexibility in how those requests are processed. For instance, if the ETV 210 is under heavy load and there is queuing of requests at the credit engine 230, the operator of the ETV 210 may decide that cancel requests should jump to the front of that queue inside the credit engine 230 and thereby be given priority over taker orders. For example, an uncertain order is pending review by the credit checking engine 230. Any subsequent related orders (such as being related to the same instrument) are forwarded to the credit checking engine 230 based on the indication that the taker order and each of the plurality of contra-orders are indicated as uncertain. On the other hand, an order indicated as certain is matched by the matching engine 220 without transmission of the entire order details to the credit checking engine 230.

To illustrate pipelined credit checking further, reference will be made to FIGS. 3-7. FIG. 3 illustrates an example of a method 300 of matching by a matching engine 220 of the ETV 210 in conjunction with the credit engine 220. At 302, the method 300 may include receiving a message from a market participant 201. At 304, the method 300 may include determining whether the message encodes a taker order, which is an order that is taking liquidity (usually this means it is a buy order with a limit price greater than or equal to the prevailing offer for the instrument on the ETV 210, or a sell order with limit price less than or equal to its prevailing bid).

If the encodes a taker order, then at 306, the method 300 may include finding price compatible contra-orders and sending the taker order and price compatible contra-orders to the credit engine 230 and marking all sent orders as ‘uncertain.’

If the message is not a taker order, then at 308, the method 300 may include determining whether the message that affects an order that is marked “uncertain.”

If the message affects an order marked as uncertain, then at 316, the method 300 may include forwarding that message to the credit engine 230. In this example, the message may be a cancel or cancel-replace request, although other types of orders may be encoded by that message. The credit engine 220 will then process that message according to the ETV's matching rules.

Returning to 308, if the message does not affect an order marked as uncertain, then at 312, the method 300 may include determining whether the message converts a passive order to a taker order (such as by adjusting its limit price such that it crosses the bid-ask spread). If so, then the message is treated the same way as in the first case—it is bundled with all the contra orders, and they are marked ‘uncertain’ and sent off to the credit engine at 306.

If the message does not convert a passive order to a taker order, then the message is processed as it would be by an otherwise unmodified matching engine—independently of the credit engine and according to the ETV's rules that are also implemented in the matching engine at 314.

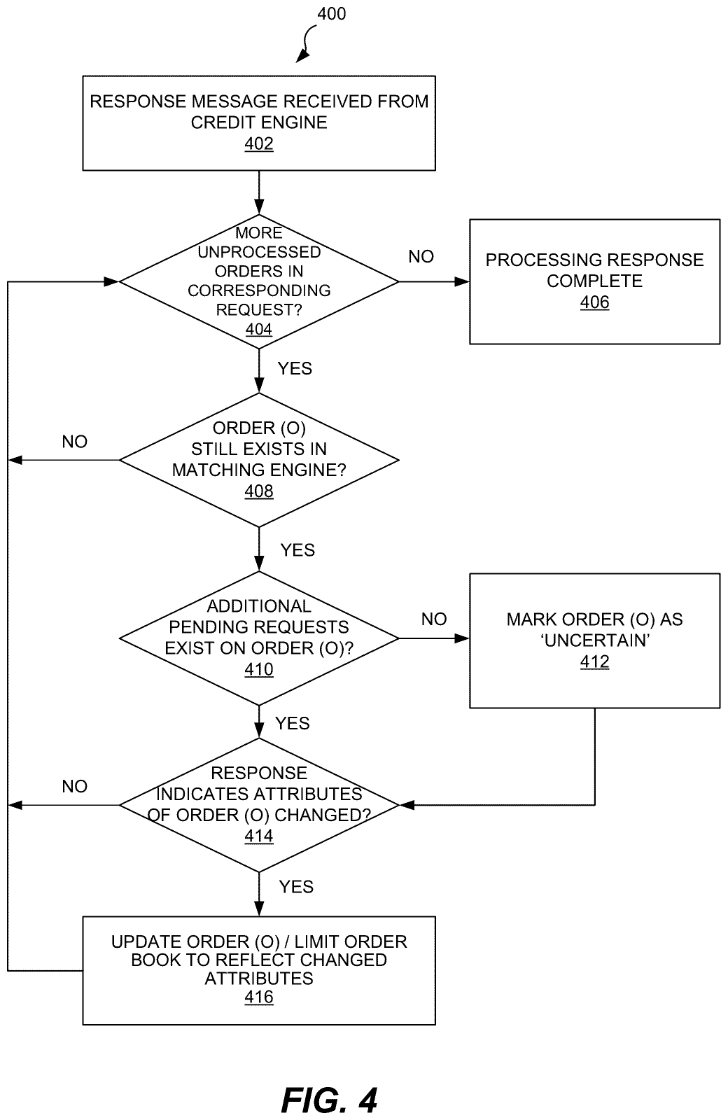

FIG. 4 illustrates an example of a method 400 for processing by the matching engine 220 a result of a credit engine 230 of the electronic trading venue. At 402, the method 400 may include receiving a response message from the credit engine 230. At 404, the method 400 may include iterating through orders to determine whether any orders O exists in the matching engine 220. For example, each order O that was sent in the corresponding request to which the response pertains is processed one-by-one until no such unprocessed orders remain, at which time the matching engine's processing of the credit engine's response is complete. If the order O no longer exists in the matching engine 220 because it was previously closed, canceled or completely filled then processing then processing of O is complete at 406. If, however, order O does exist and there are no additional pending requests (410) on it subsequent to the one to which the current response pertains then it is marked by the matching engine as ‘certain’ (i.e., unmarked as ‘uncertain’) at 412. At 414, if the response indicates that no attributes of the order O have changed (and there are no additional pending requests), the processing of O is complete at 406. If, however, the response indicates that attributes of order O have changed the matching engine may conclude processing of O by applying the changes indicated in the response message to O and its instrument's limit order book 222 at 416. Examples of such attribute changes may include a change in visible quantity of an iceberg order, a change in the cumulative or open quantity of an order, a change in the temporal position of the order in the instrument's limit order book due to a replacement on O to a new price-level or increase in original quantity, cancelation/removal of O from market, and so on.

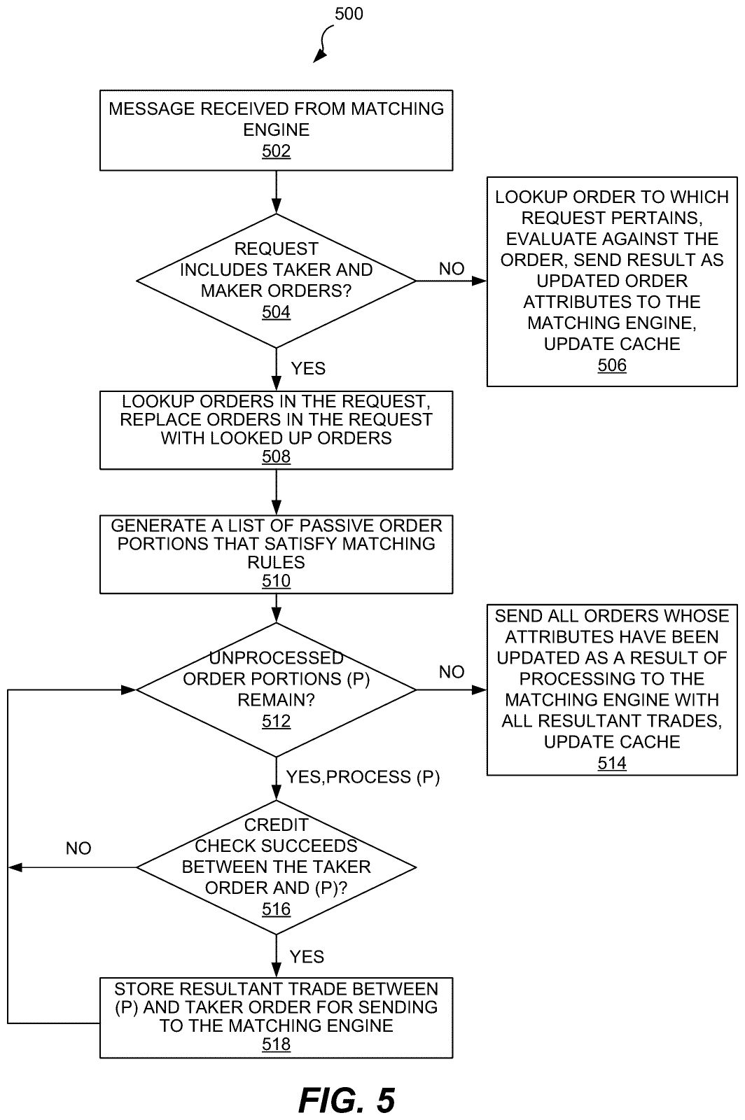

FIG. 5 illustrates an example of a method 500 for processing by the credit engine 230 a non-blocking message from the matching engine 220.

At 502, the method 500 may include receiving (by the credit engine 230) a request message from the matching engine 220. At 504, the credit engine 230 may determine whether the request message includes one or more taker orders and one or more maker orders. If it does not, then it likely contains a cancel or cancel-replace request and it is processed at 506 by looking up the credit engine's cache of orders at cache 233 to find orders to which the request pertains, processing the request against that order and sending the result as a response back to the matching engine 220. Non-limiting examples of results could be a ‘cancel-reject’ because the looked-up order has already been completed filled, or modified order attributes if a cancel-replace succeeds in replacing an existing order to a new size or price level. The cache 233 is updated to refer to this new version of the affected order.

Returning to 504, if the request message includes a taker order and corresponding price-compatible contra orders, then the most recent versions of those orders are looked-up in the cache 233 at 508, and where they are found replace any older version of the same order in the request. This ensures the credit engine 230 will operate on the most up-to-date versions of each order in the request message, and not on an older version, which may include a lagging filled quantity. At 510, the credit engine 230 may generate a list of passive order ‘portions’ the ordering of which is consistent with the matching rules for the ETV. Portions of orders and not, say, individual orders are likely to be necessary in the production of such a list because on most ETVs the hidden quantity of an iceberg order has lower priority than its visible tip and indeed any other visible quantity from regular limit orders at the price-level in the book. In this scenario the iceberg would be split into a portion associated with its tip that would appear nearer the front of the list, and one or more portions associated with its hidden quantity that would be nearer the back of the list.

Having created a priority list of passive order portions the items in that list are processed one-by-one until either no such portions remain (512) or the taker order against which they are subject to matching is completely filled. If the credit check between the taker order and passive order portion succeeds (516), a match record is generated and stored to be sent later at 518. If the credit check fails (516) then that passive order portion is skipped and any next unprocessed portion is checked at 512. Credit checking in non-blocking messaging is unmodified compared to credit checking in blocking messaging systems insofar as both involve ascertaining from the taker order and passive order portion the two counterparties, finding the credit lines between them, and in the event of success drawing down those lines by the size of the trade on the order portion. When processing of all maker orders is complete or the taker order is completely filled, then at 514 the trades and updated order attributes are sent in the response to the matching engine. All trades on distinct portions from the same order may be ‘summed’ into a single such trade before sending. The credit engine 230 updates its cache 233 with the latest versions of all such orders.

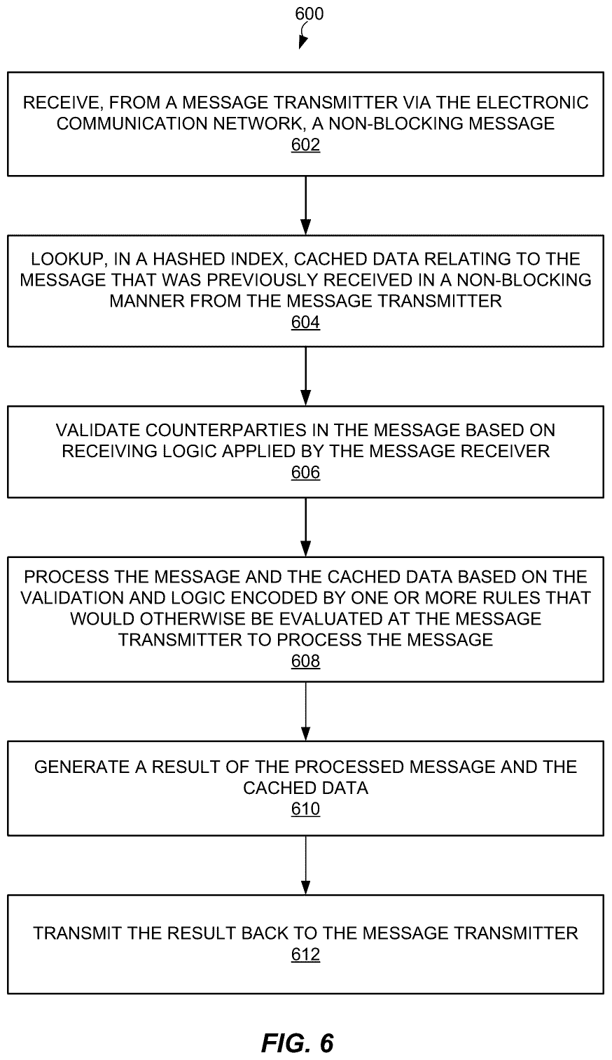

FIG. 6 illustrates an example of a method 600 of non-blocking messaging to reduce congestion and execution time in an electronic communication network. At 602, the method 600 may include receiving, from a message transmitter (such as the message transmitter 120 illustrated in FIG. 1B) via the electronic communication network, a non-blocking message.

At 604, the method 600 may include looking up, in a hashed index, cached data relating to the message that was previously received in a non-blocking manner from the message transmitter. The cached data may be a hashmap cache, such as the cache 233 illustrated in FIG. 1B.

At 606, the method 600 may include validating counterparties in the message based on receiver logic (such Rx logic 131 illustrated in FIG. 1B) as applied by the message receiver.

At 608, the method 600 may include processing the message and the cached data based on the validation and logic encoded by one or more rules (such as the Tx logic 121 illustrated in FIG. 1B) that would otherwise be evaluated at the message transmitter to process the message.

At 610, the method 600 may include generating a result of the processed message and the cached data.

At 612, the method 600 may include transmitting the result back to the message transmitter.

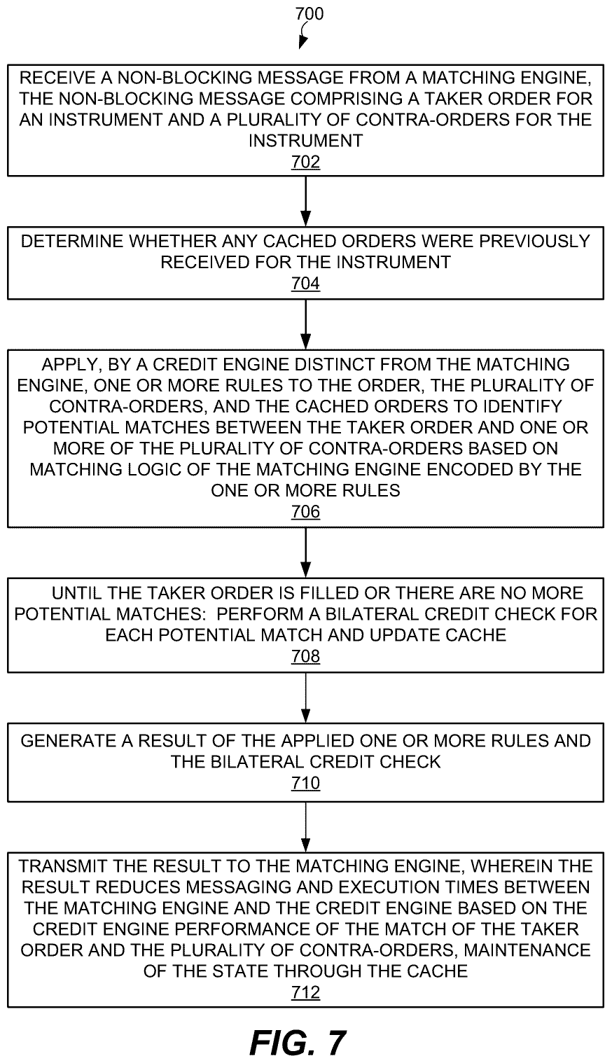

FIG. 7 illustrates an example of a method 700 of an electronic trading venue that implements non-blocking messaging to reduce congestion and execution time in an electronic communication network.

At 702, the method 700 may include receiving a non-blocking message from a matching engine 220, the non-blocking message comprising a taker order for an instrument and a plurality of contra-orders for the instrument.

At 704, the method 700 may include determining whether any cached orders were previously received for the instrument.

At 706, the method 700 may include applying, by a credit engine 230 distinct from the matching engine, one or more rules to the order, the plurality of contra-orders, and the cached orders to identify potential matches between the taker order and one or more of the plurality of contra-orders based on matching logic of the matching engine encoded by the one or more rules (such as match rules used by the ETV 210).

At 708, the method 700 may include, until the taker order is filled or there are no more potential matches: identifying the next potential match in the plurality of potential matches. For the next potential match: performing a bilateral credit check to determine whether a taker market participant that submitted the taker order and a market participant that submitted a contra-order of the potential match have sufficient bilateral credit to complete the potential match, and updating update the cache 233 that maintains a state of the taker order based on the determination.

At 710, the method 700 may include generating a result of the applied one or more rules and the bilateral credit check.

At 712, the method 700 may include transmitting the result to the matching engine, wherein the result reduces messaging and execution times between the matching engine and the credit engine based on the credit engine performance of the match of the taker order and the plurality of contra-orders, maintenance of the state through the cache 233.

### Further Improvements to the ETV 210

The description of the invention in the previous section is intended to be largely pedagogical in nature. In this section various optimizations to the scheme are described that may improve its efficiency and/or efficacy.

Message size reduction with integer order identifiers. In some matching engine implementations each order message on an instrument is given a unique integer identifier. If key attributes of the order are not modifiable (e.g., limit price, original quantity) after assignment of this integer identifier, and if the matching engine keeps track of which orders it has previously sent to the credit engine then subsequent transmission of that order may advantageously involve sending only the integer identifier of the order and not its other attributes (such as its limit price, counterparty who submitted it, its side, etc.). On a per instrument basis the cache of orders at the credit engine may be indexable by the integer e.g., using a hash map.

Message size reduction with integer request identifiers and implicitness. To tie a request and its response together the matching engine may include a unique integer identifier in each new request message sent to the credit engine. The credit engine may include that unique identifier in its response to the matching engine. Rather than send back all the orders that appeared in the request, the absence of an order from a response message may implicitly indicate that there are no updates to any of the orders in the corresponding request at the matching engine. Advantageously this ‘implicitness’ approach may reduce message size. Further, when an order is modified it may be implicit that only the fields that have changed in the order and not the entirety of its fields are sent in the response. Finally, if updates to an order can be calculated exclusively from the trade record sent in the response it may be implicit that those updated fields on the involved orders are calculated at the matching engine entirely from the trade record.

Batching of taker orders. Disclosed in U.S. Pat. No. 10,325,317B2, entitled “Ideal Latency Floor,” issued on Jun. 18, 2019, the entirety of which is incorporated by reference herein for all purposes, is a scheme for batching together competing taker orders. Since all such competing taker orders are drained from such a batch atomically, at substantially the same time, rather than send to the credit engine one request for each taker order, one-by-one, all taker orders may be sent in a single request along with the superset of contra passive orders they are each price-compatible with for ‘splitting by taker order7’ at the credit engine. This may serve to reduce messaging between the matching engine and credit engine.

Matching engine cache indicating existence of a credit relationship. Each matching engine instance may be provided with a local cache of credit relationships (e.g., at the start of the trading session, by the credit administration system, as a file). These relationships may be collapsed from having a magnitude and type (e.g. net or gross limit) as they likely would in the credit engine and credit administration system, to a simple ‘yes’ or ‘no’, that such a credit line (bilaterally) exists. To the extent this list is mostly static (e.g., credit between two counterparties is exhausted for the day/instrument/tenor, or a credit relationship simply does not exist between the counterparties) the matching engine can incorporate checking of this list into what would otherwise be the price-compatibility check described throughout this document. So, for instance, if a taker order was received from counterparty A that was only price compatible with a single passive order from counterparty B, and the matching engine interrogated its local cache of credit to determine that no credit relationship exists between A and B, then there is no need for the matching engine to forward those two orders as a request to the credit engine. This may reduce messaging traffic to the credit engine and improve response time in processing matches. It may also advantageously be used to exclude certain passive orders from being sent when there are a plurality of such passive orders against which the taker is price-compatible.

Pruning of cache at credit engine. The cache of orders at the credit engine need not grow indefinitely. After an order is closed because it has been completely filled or canceled the credit engine may remove it from the cache to improve memory efficiency and lookup time. If this scheme is used in conjunction with the ‘send the entire order once only from the matching engine, then subsequently only send the order identifier’ scheme mentioned above, it would be implicit that if an order id (only) were received for which there was no corresponding entry in the credit engine's hashmap cache, then the order may be determined to have been closed. In this way orders may be removed from the cache once they have been closed (i.e., filled or canceled).

Delayed insertion of taker orders into the order book. Orders with a persistent time-in-force (e.g., good-till-canceled) that cross the bid-ask spread may not be inserted into the limit order book at the matching engine until a response has been received from the credit engine or it has otherwise been determined they lack credit to trade on entry. Advantageously this approach may avoid flickering of a ‘crossed market’ while credit checking on such an order is pending. While these orders may experience a delay being inserted into the book so as not to appear in market data, it may nevertheless be beneficial to include them in the matching engine's private view of the prevailing bid and ask. In this way a good-till-canceled order that crosses the spread but does not (completely) fill on entry will not have time priority violated because despite being withheld from the book the matching engine will still send it to the credit engine as a passive order if a subsequent taker order is received with which it is price compatible, while its own initial request as taker is pending.

### Coordination of Temporal identifiers

The systems and methods disclosed above may be referred to as non-blocking messaging. The foregoing may be used in various contexts in which a message blocks another message. In particular, one example context may be used for pipelined credit checking in which a credit engine 230 performs at least some functions ordinarily performed by a matching engine 220. The above disclosures may improve an ETV performance in its order matching functionality by sending groups of taker orders and price-compatible contra (maker) orders from the venue's matching engines to the venue's credit engine in a non-blocking manner. It is evident in that disclosure that certain logic that would otherwise conventionally only exist in the venue's matching engine component may need to be duplicated (in whole or in part) and/or migrated into the venue's credit engine component. It is further evident in that disclosure that additional information beyond that conventionally transmitted between the venue's matching engine components and credit engine may be required to support the distribution of that logic.

The disclosures that follow are further techniques and optimizations for non-blocking messages, and that communication that may improve the efficiency of non-blocking messages and in particular to pipelined credit checking. Upon receipt of an order message for a given instrument's limit order book, a conventional matching engine may assign a unique temporal identifier to that message. This may especially be the case when orders messages are received at a higher rate than that of the venue's clock resolution (e.g., clock resolution of only whole milliseconds but multiple orders received within a millisecond), or when orders are not necessarily presented to the book in the same sequence to that in which they were received (see e.g., U.S. Pat. No. 11,798,077B2, entitled “Ideal Latency Floor”, which is incorporated by reference in its entirety herein for all purposes), or simply for ease of auditability and/or recovery purposes. Such a temporal identifier, when assigned to an order message, may indicate the sequence in which that order was inserted into or processed against the book. Lower valued temporal identifiers may indicate orders processed earlier; higher may indicate those processed later. Such a temporal identifier may be implemented by the venue's matching engine component as a per book integer counter, initialized to “0” and incremented before its value's assignment to each new order received for that book.

When certain types of orders on a venue are matched as price making orders, it is conventional to send them to the back of the order queue at their price-level the limit order book. Iceberg orders are a (non-limiting) example of this type of order. When the visible quantity of an iceberg is exhausted by a match that visible quantity is replenished from the iceberg's hidden quantity, and the iceberg is sent to the back of the queue at its price-level where it may receive additional matches, again until its visible quantity is exhausted. The process repeats on the iceberg until either it is canceled by the user, or it expires, or it is completely filled (i.e., is hidden and visible quantities are reduced to zero through matching). To ensure its temporal ID accurately reflects its (new) position in the queue at the price level, a matching engine 220 may reassign that iceberg's temporal ID from its temporal ID counter, essentially treating it as if it were a new order being inserted into that book. As previously noted, groups of competing taker orders and price-compatible contra (maker) orders may be sent from the matching engine 22 to the credit engine 230 in a single credit request message. The disclosures that follow will assume that at the time of sending that request message all orders in it will have been assigned a temporal order id using the book's temporal counter id maintained by the matching engine 220. Prior to sending the request, however, the matching engine 220 may (unconventionally) reserve a range of temporal ID's for use by the credit engine 230 should of any of the iceberg (or similar) orders appearing in the contra list of the request match and require repositioning as a result thereof.

The matching engine 220 may reserve this range of temporal IDs for possible matches by first copying the temporal ID counter's value into a new field ‘min temporal ID’ in the credit request message, then immediately incrementing the temporal ID counter by the number of iceberg (or similar) orders that appear in the request's contra list. In this way, if all such orders in the contra list are repositioned at the credit engine 230 there will be precisely enough temporal identifiers reserved to assign each a new (and unique) temporal identifier from that range to indicate each's new temporal position. The credit engine 230 may, likewise, obtain this specific range of temporal IDs reserved for its use in repositioning from the ‘min temporal ID’ field in the request and by the counting the number of iceberg (or similar) order types in the list of contra orders in that same request.

Upon receipt of a credit request, the credit engine 230 may lookup its cache of orders and replace any orders appearing in the request with later the version thereof found in its cache. Having obtained the latest version of each of the orders, the credit engine 230 may convert the list of contra orders into a limit order book using the price and temporal identifiers information on each such order to do so. Having created a limit order book for the contra orders (herein, the ‘contra book’), the credit engine 230 may now process the competing taker orders one-by-one against that contra book, in the sequence determined by the temporal ID's of those taker orders.

While the processing of each taker order in the request against the limit order book may otherwise be consistent with a conventional matching operation involving a credit check (see also U.S. patent application Ser. No. 17/886,587 entitled “Deterministic Credit System”), the logic for matching iceberg (or similar) orders may additionally be implemented in the credit engine 230. Any icebergs that are sent to the back of the queue in the contra book as a result of match-and-replenishment are kept track of by the credit engine 230 (such as by adding them to a hash set associated with the request). Upon completion of the matching operation over all the takers in the request, the credit engine 230 may ‘walk’ the price-levels in what remains in the contra book post-matching and if that contains repositioned iceberg (or similar) orders to assign them temporal identifiers from the reserved range. In an implementation this may be as simple as copying the ‘min temporal ID’ field's value into a counter associated with the request, and then walking the book in a price-time priority manner, incrementing and assigning the counter's value each time an order known to have been matched-and-replenished is encountered. The latest versions of any orders affected by the matching process by the credit engine 230 back into its cache, and a response for the request is now ripe for sending back to the matching engine 220.

For the purpose of efficiency, the response message sent by the credit engine 230 to the matching engine 220 may contain only information that has changed about each order, and not information already known to the matching engine 220 through its own copy of the order. And even then, the credit engine 230 may only send information that cannot otherwise be deduced by the matching engine 220 through reconciliation of the response message with the corresponding request message. For instance, if an order with a time-in-force of immediate-or-cancel (IOC) does not match, it is not necessary for the credit engine 230 to send any information about this IOC order back to the matching engine 220. Its absence from the response message is enough for the matching engine 220 to deduce that it did not fill and thus is canceled. The matching engine 220 may use a ‘credit request counter’ to assign a unique identifier to each credit request and include that as a field in the request message sent to the credit engine 230; the credit engine 230 may provide that same field back in its response to the request to allow reconciliation of the two messages at the matching engine 220.

Upon receipt of a response message from the credit engine 230 the matching engine 220 may, as explicitly indicated in or deduced from that message, remove orders from the book; update their temporal identifiers and consequently queue positions in their limit order book; update the visible, open and filled quantities of orders in the book; and so on.

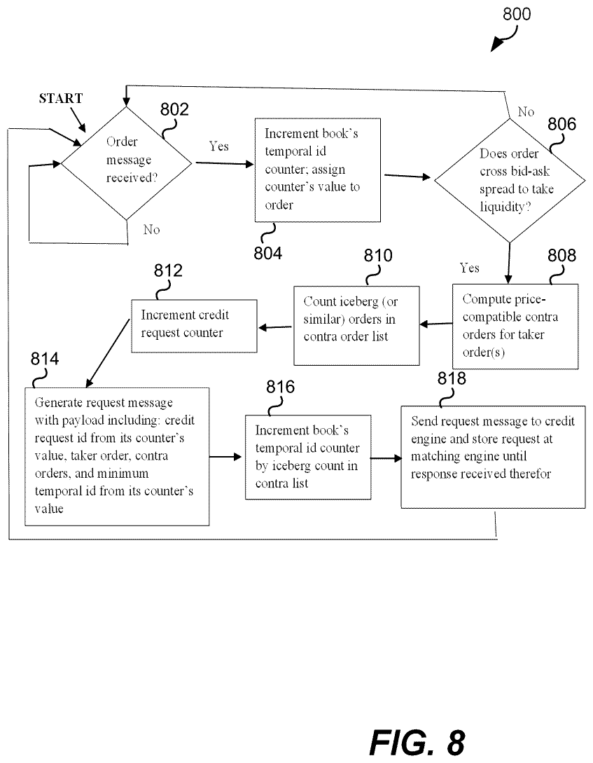

If the temporal ID counter is unchanged at the matching engine 220 between the time the credit request was sent and its response was received then the matching engine 220 may ‘unreserve’ all or a portion of that book's temporal ID counter that had previously been reserved for use by the credit engine 230 in the request. The matching engine 220 may determine the temporal ID counter is unchanged at the time the response is received, by comparing its value to the sum of the value in ‘min temporal ID’ field in on the corresponding request, and count of iceberg (or similar) orders in the contra list of that same request. If unchanged, the matching engine 220 may set the book's temporal ID counter to the maximum value among: its current value minus the iceberg count in the contra order list, or the maximum temporal ID assigned by the credit engine 230 and consequently appearing in the response message. The former will unreserve the entire range of integers previously sent to the credit engine 230; the latter may unreserve only a portion of that range. This ‘unreserving’ of temporal IDs may advantageously serve to reduce the risk of eventual integer overflow, and improve efficiency by reducing the number of bytes ultimately required to transmit the temporal ID during the trading week. FIGS. 8-10 illustrate examples of methods for the coordination of temporal identifiers between a transmitter (such as a transmitter 120 illustrated in FIG. 1 and a matching engine 220 illustrated in FIG. 2), and a receiver (such as a receiver 130 illustrated in FIG. 1 and a credit engine 230 illustrated in FIG. 2). For clarity of exposition the flowcharts in FIGS. 8-10 illustrate the processing of only a single taker order, though as described in the preceding text a plurality of competing taking orders may be sent in a request (e.g., as a result of draining an ideal latency floor taker batch).

FIG. 8 illustrates an example of a method 800 for generating credit request and initial assignment of temporal ID's upon receipt of a taker order. In some examples, the matching engine 220 may implement the method 800. At 802, the method 800 may include determining whether an order message has been received. If not, monitoring for an order message may be repeated until an order message is received. If an order message is received, at 804, the method 800 may include incrementing the book's (such as a limit order book 222) temporal ID counter and assigning the counter's value to the order message.

At 806, the method 800 may include determining whether the order crosses the bid-ask spread to take liquidity. If not, the method 800 may return to 802. If so, at 808, the method 800 may include computing one or more price-compatible contra orders for taker order(s). At 810, the method 800 may include counting iceberg (or similar) orders in the contra order list. At 812, the method 800 may include increment a credit request counter. At 814, the method 800 may include generating a request message with a payload that includes: a credit request ID from its counter's value, a taker order, one or more contra orders, and a minimum temporal ID from its counter's value.

At 816, the method 800 may include incrementing the book's temporal ID counter by iceberg count in contra list. At 818, the method 800 may include sending a request message to the credit engine (such as the credit engine 230) and storing the request at the matching engine until a response from the credit engine is received. The method 800 may then return to 802 to continue monitoring for new order messages.

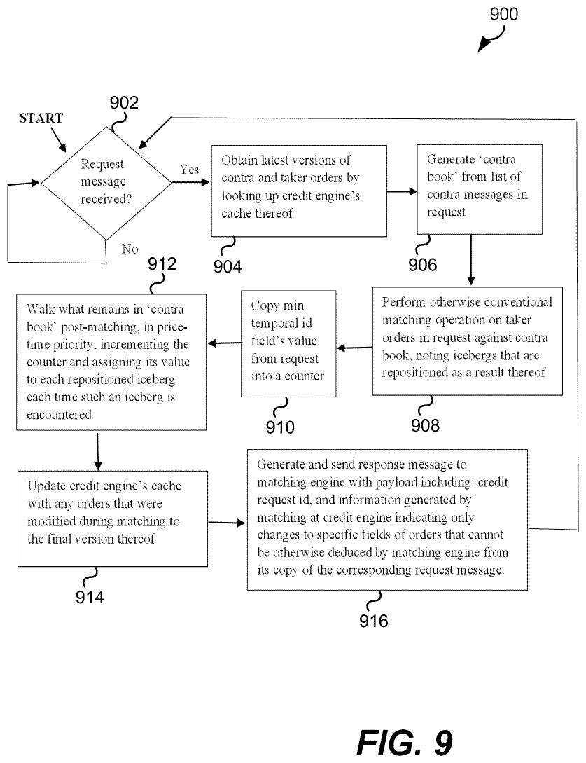

FIG. 9 illustrates an example of a method 900 for processing request received from the matching engine (such as the matching engine 220). In some examples, the credit engine 230 may implement the method 900. At 902, the method 900 may include determining whether a request message (such as from the matching engine as described in FIG. 8) has been received. If not, monitoring for a request message may be repeated until a request message is received. If a request message is received, at 904, the method 900 may include obtaining latest versions of contra and taker orders by looking up the credit engine's cache. At 906, the method 900 may include generating a ‘contra book’ from the list of contra messages in the request message.

At 908, the method 900 may include performing matching operation on taker orders in the request message against the ‘contra book’ created at 906, noting icebergs that are repositioned as a result thereof. At 910, the method 900 may include copying the minimum temporal ID field's value from the request message into a counter. At 912, the method 900 may include walking what remains in the ‘contra book’ post-matching in price-time priority, incrementing the counter and assigning its value to each repositioned iceberg each time such an iceberg is encountered.

At 914, the method 900 may include updating the credit engine's cache with any orders that were modified during matching to the final version thereof. At 916, the method 900 may include generating and sending the response message to the matching engine with a payload that includes: a credit request ID and information generated by matching at the credit engine, which may include only changes to specific fields of orders that cannot be otherwise deduced by the matching engine from its copy of the corresponding request message.

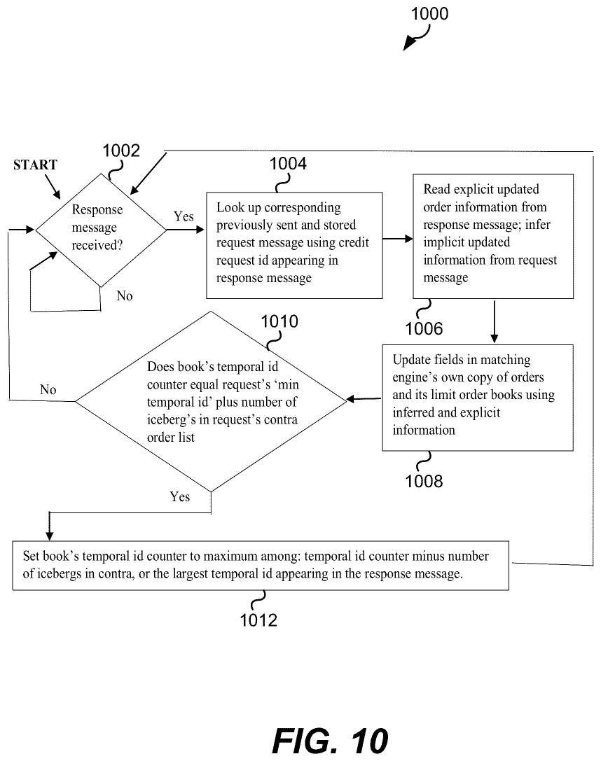

FIG. 10 illustrates an example of a method 1000 for processing a response received from the credit engine (such as the credit engine 230). In some examples, the matching engine 220 may implement the method 1000. At 1002, the method 1000 may include determining whether a response message (such as from the credit engine as described in FIG. 9) has been received. If not, monitoring for a response message may be repeated until a response message is received.

If a response message is received, at 1004, the method 1000 may include looking up a corresponding previously sent and stored request message using the credit request ID in the response message. At 1006, the method 1000 may include reading explicit updated order information from the response message and inferring implicit updated information from the request message. At 1008, the method 1000 may include updating fields in the matching engine's copy of orders and its limit order books based on the inferred and explicit information.

At 1010, the method 1000 may include determining whether the book's temporal ID counter equals the request's minimum temporal ID plus number of icebergs in request's contra order list. At 1012, the method 1000 may include Set book's temporal ID counter to maximum among temporal ID counter minus number of icebergs in contra, or the largest temporal ID appearing in the response message.

### Pre-Send Pruning of Contra Orders

In a single credit request, in a basic implementation of the disclosures of FIG. 1-7, a group of one or more competing taker orders (see e.g., Ideal Latency Floor) may be sent with all price-compatible contra orders in the instrument's book from the matching engine to the credit engine. This may result in quite a large number of contra orders being sent to the credit engine that will never actually match. This is especially true when the quantity of a taker order is quite small but the limit price of that taker orders reaches quite ‘deep’ into the book. Disadvantageously, sending so many contra orders may cause the cache of orders to grow at the credit engine, may cause relatively long delays in constructing, transmitting, reading and processing (and so on) the credit request message due to its sheer size.

Techniques for reducing the number of maker orders (or references thereto as ‘keys’, see section ‘Order Cache at Credit Engine’) sent in the credit request are as follows. First, each taker order sent in the request has a specific quantity of the instrument that it seeks to buy or sell (its ‘open quantity’). Although the matching engine component may have only limited (or even no) knowledge of the credit relationships between makers and takers, for a given such taker order it is a fact that taker order can only match with, at most, its open quantity with each specific maker in the book. If there are a plurality of such contra orders in the book from a given maker, then it follows regardless of credit, that the taker can only match with up to ‘open quantity’ with any given maker. Noting that there is a priority in which maker orders are matched (usually price-time), only the first ‘open quantity’ worth of orders from each maker need to be sent to the credit engine from the matching engine; orders from that maker with lower priority after that maker has met the taker's open quantity from prior orders need not be sent. In this way those remaining contra orders from a maker that are otherwise price compatible may be ‘pruned’ from (i.e., not sent) in the request to the credit engine.

The ‘pruned’ set of contra orders that need to be sent to the matching engine may be computed by the matching engine as follows. From the entire list of price-compatible contra orders create one limit order book per maker, containing only that maker's contra orders. This, of course, may be achieved using the limit prices, temporal identifiers and sender fields on those contra orders. Now assume there exists infinite bilateral credit between maker and taker and under this assumption simulate a matching operation on the first taker's order and the first maker's book to compute the first ‘open quantity’ worth of maker orders against which that taker order may match. Add only these ‘open quantity’ worth of maker orders to the set of such to be sent to as the pruned contra list. If an order is encountered in that maker's book during the simulated match that is marked as ‘uncertain’ (per the original disclosure) or has an unacks set with non-zero size (per this disclosure, see section ‘Unacks’) and the entire open quantity worth of maker orders has not yet been met, add that ‘uncertain’ maker order to the set of such to be sent as the pruned list without consideration of its quantity. Repeat this process thereby generating per maker limit order books and simulating the matching of a taker order against them for all combinations of taker orders and makers in the credit request.

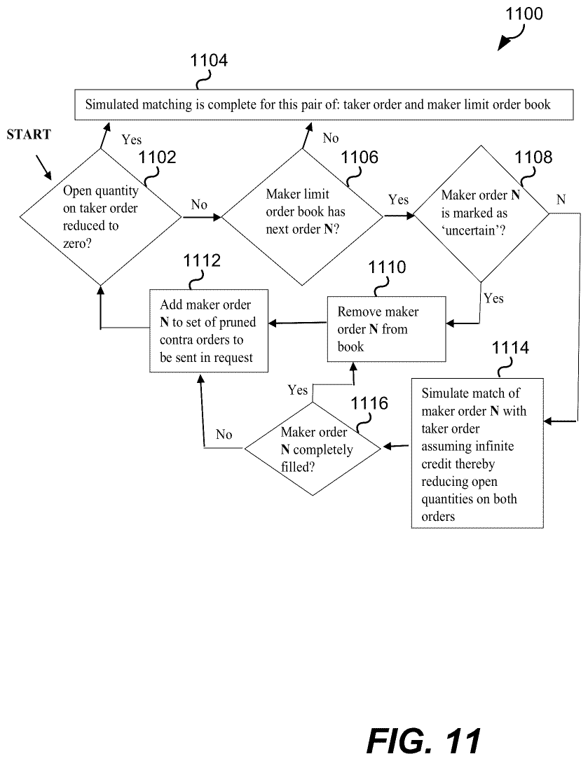

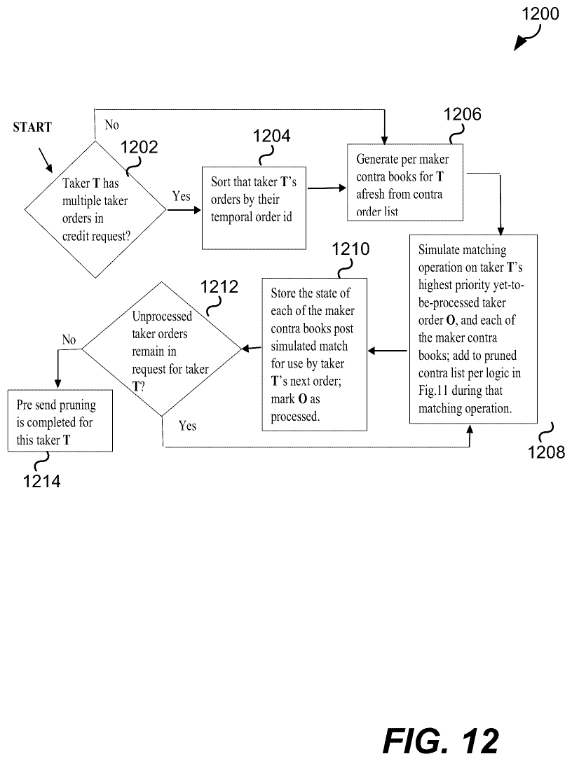

In the special case where the same taker has multiple taker orders in the request process those taker orders in their correct temporal order, but do not regenerate the maker order books after each simulated matching event for each of that taker's orders. Instead simulate matching on the taker's next order against only what remains in each maker's limit orders book after simulated matching was performed on the taker's previous order. FIGS. 11 and 12 illustrates examples of methods for pruning contra orders.

FIG. 11 illustrates an example of a method 1100 of simulated matching for the pair of taker order and maker limit order book. The method 1100 may be repeated across all pairs of taker orders and maker limit order books to determine the final pruned contra order list to be sent from the matching engine (such as the matching engine 220) in a credit request.

At 1102, the method 1100 may include determining whether an open quantity on a taker order has been reduced to zero. If so, at 1104, simulated matching is complete for this pair of taker order and maker limit order book. If not, at 1106, the method 1100 may include determining whether the maker limit order book has a next order N? If so, at 1108, the method 1100 may include determining whether the maker order N is marked as “uncertain.” If so, at 1110, removing the maker order N from the book. At 1112, the method 1100 may include adding the maker order N to set of pruned contra orders to be sent in the request. The method 1100 may then return to 1102.

Returning to 1108, if the maker order N is not marked as “uncertain,” at 1114, the method 1100 may include simulating a match of maker order N with one or more taker orders, which may assume infinite (unlimited) credit to reduce open quantities on both orders. At 1116, the method 1100 may include determining whether the maker order N is completely filled. If so, then the maker order N may be removed from the book at 1110. If not, then the maker order N may be added to the set of pruned contra orders to be sent in the request at 1112.

FIG. 12 illustrates an example of a method 1200 for processing a case in which a taker has multiple taker orders in the same request. In this case, the maker contra books resulting from simulated matching on higher priority orders from that taker are fed back into simulated matching for lower priority orders from that same taker (as opposed to being created a fresh each time from the contra order list).

At 1202, the method 1200 may include determining whether a taker T has multiple taker orders in the credit request. If not, the method 1200 may proceed to 1206. If the taker T has multiple taker orders in the credit request, at 1204, the method 1200 may include sorting that taker T's taker orders by their temporal order ID, and then proceeding to 1206. At 1206, the method 1200 may include generating, per maker, new contra books for T based on the contra order list.

At 1208, the method 1200 may include simulating a matching operation on taker T's highest priority yet-to-be-processed taker order O, and each of the maker contra books and adding, to pruned contra list, during that matching operation. For example, the maker operations described at FIG. 11 (FIG. 4) may be used for pruned contra lists.

At 1210, the method 1200 may include storing the state of each of the maker contra books post simulated match for use by taker T's next order, mark O as processed. At 1212, the method 1200 may include determining whether unprocessed taker orders remain in the request for taker T. If so, the method 1200 may return to 1208. If not, at 1214, pre-send pruning is completed for this taker T.

### Credit Failure Between a Maker and Taker

A technique for performing the matching operation on an electronic trading venue is to ‘walk’ the limit order book in price-time priority attempting to match each contra (maker) order as it is encountered (throughout that walk) with the taker order. Such a matching operation may conventionally terminate when no further contra orders remain in the book that are price compatible with the taker order, or when the taker order is completely filled.

On a trading venue (such as ETV 210) that operates on the basis of bilateral credit (cf. one that operates with central clearing), determining whether each pair of a maker and taker order can match (and to what extent i.e., up to what quantity) during the matching operation conventionally involves a credit check. The same can be said for the process of producing credit-screened market data updates on such a venue. To the extent that a plurality of distinct maker orders is involved in either credit screening or in the matching operation an (non-obvious) optimization for dealing with such is described below.

In an implementation the result of a credit check between a taker order and contra (maker) order may be categorized in one of three ways: completely successful, partially successful, or not successful. For this optimization, no action is required when the credit check is completely successful. In the ‘completely successful’ situation the full amount of the smaller of the two orders is matched by the credit check. In the remaining two situations, respectively, only a partial amount (on the smaller of the two orders) or no amount at all is matched between the orders by the credit check. These remaining two situations indicate that either credit between the maker and taker has been exhausted, or that it never bilaterally existed. We may thus consider both these situations as a form of credit failure between the maker and taker.

When a credit failure occurs between a maker and taker during a specific instance of the matching operation or a specific instance of credit screening (noting that many such distinct instances of both occur throughout the trading day), we may avoid performing further credit checks between that specific maker and taker for the remainder of that instance. In an implementation this may involve inserting into a hash set (specific to the instance) a string identifying the maker on which the failure occurred (noting it is unnecessary to likewise store the taker because the taker is usually fixed per instance). Upon processing the next maker (contra) order, a credit check is only performed if the maker does not exist in that hash set. This has at least two advantages: one is that the credit check operation is usually computationally expensive whereas looking up a hash set is not, thereby improving performance. The second is that certain issues that may otherwise manifest when each maker order's limit price is used in the computation of the credit are avoided. For instance, if the credit system deals in USD and the best bid for gbp/usd is 1.20 then the amount of credit consumed by a 1 mio order of gbp/usd would be $1.2 mio USD. If deeper in the bid book there is a bid at say 0.80 for gbp/usd then the amount of credit consumed by a 1 mio order of that size would be only $0.8 mio USD. Counterintuitively, and absent the technique described here, with only 1 mio USD remaining in the credit line (and the venue having orders of lot size 1 mio of base currency) the worse priced bid would pass the credit check whereas the better priced bid would not. The hash set technique described here thus advantageously prevent worse-priced maker liquidity appearing in credit-screened market data or being matched.

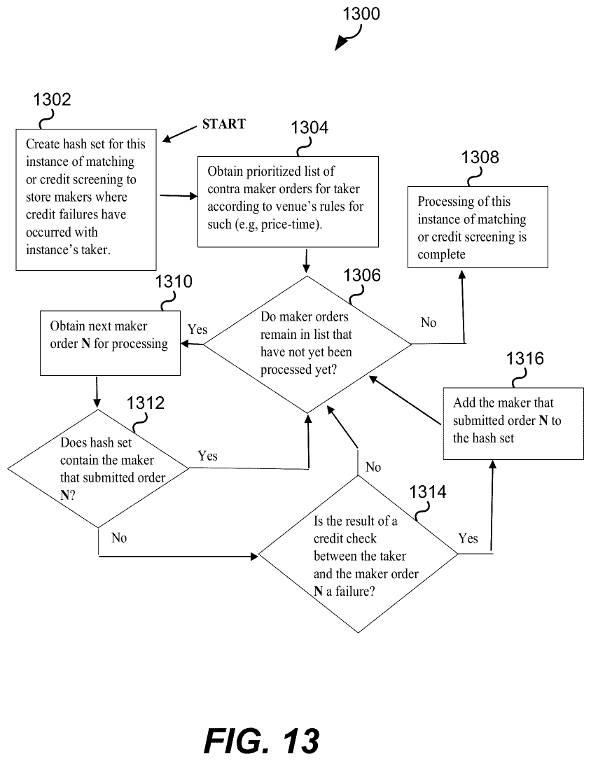

On a trading venue, the credit engine component may implement the technique described above, as may the market data distributor component(s). FIG. 13 illustrates an example of a method 1300 for skipping subsequent orders from a given maker after an initial credit check failure between that maker and taker during an instance of either matching or credit screening. At 1302, the method 1300 may include creating a hash set for this instance of matching or credit screening to store makers where credit failures have occurred with instance's taker. At 1304, the method 1300 may include obtaining a prioritized list of contra maker orders for taker according to the venue's (such as the ETV 210's) prioritization rules, such as price-time rules.

At 1306, the method 1300 may include determining whether maker orders remain in the list that have not yet been processed. If not, at 1308, processing of this instance of matching or credit screening may be complete. If maker orders remain, at 1310, the method 1300 may include obtaining the next maker order N for processing. At 1312, the method 1300 may include determining whether the hash set contains the maker that submitted order N. If so, the method 1300 may return to 1306. If not, at 1314, the method 1300 may include determining whether the result of a credit check between the taker and the maker order N is a failure. If not, the method 1300 may return to 1306. If the result of a credit check between the taker and the maker order N is a failure, then at 1316, the method 1300 may include adding the maker that submitted order N to the hash set. The method 1300 may then return to 1306.

### Piggybacking Canceled Order Information

In an implementation of the disclosures of FIG. 1-7, a cache of orders is maintained at the credit engine because there are points in time where only the credit engine (and not the matching engine) knows with certainty the precise state of an order (e.g., its temporal identifier, its open quantity, whether it has been completely filled, and so on). Under certain specific circumstances the credit engine can itself compress or purge orders from its cache. However, in other situations the credit engine cannot itself purge orders that have been successfully canceled by participants. Disadvantageously this may mean that the cache of orders at the credit engine continually grows during the trading week, thereby increasingly cache lookup time and reducing the amount of memory that remains for use by other aspects of the credit engine and/or by other processes on its same physical computer.

In an implementation, identifying information for each persistent (e.g., non-IOC) order that (i) the matching engine knows to have been canceled, and (ii) that was previously sent in a credit request, may be queued at the matching engine. Upon construction of a new credit request (which itself is responsive to the receipt of a taker order, or draining of latency floor taker batch) these canceled-yet-previously-sent orders may be dequeued and sent by the matching engine in that credit request message. In this way these canceled-yet-previously-sent orders ‘piggyback’ on a credit request advantageously avoiding the overhead of additional messaging or additional message types between the matching and credit engines. Upon receipt of this piggybacked information, the credit engine may lookup the canceled-yet-previously-sent orders in its cache and safely remove them from it.

In an implementation the matching engine may ensure that an order can uniquely be identified by its instrument and a unique integer id. The unique identifier may be immutably assigned to each order upon its receipt by the matching engine through the use of a counter, in a manner not dissimilar to that described earlier for the assignment of temporal IDs. An extra optional and repeating field may be added to the credit request to store the piggybacked canceled order identifiers, which under this order identification scheme would constitute the pair of instrument and integer identifier for each such canceled order.

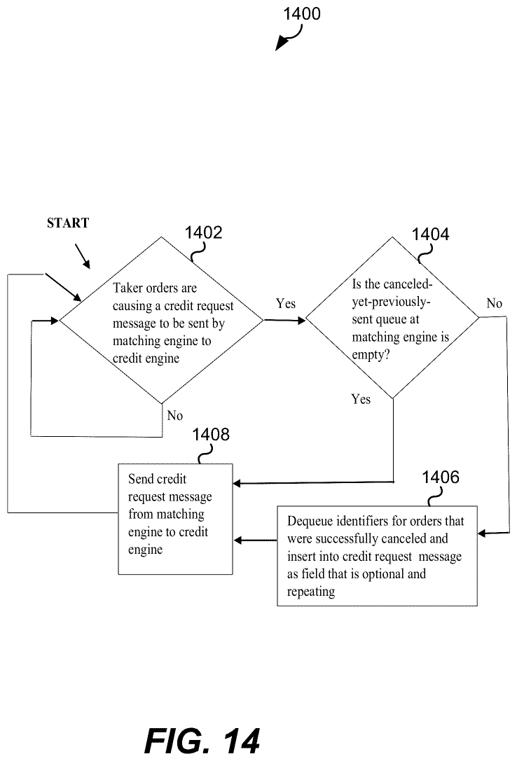

FIG. 14 illustrates an example of a method 1400 for piggybacking canceled order information in credit request at the matching engine (such as the matching engine 220), so successfully canceled orders can be purged from the credit engine's (such as the credit engine 230's) cache.

At 1402, the method 1400 may include determining whether taker orders are causing a credit request message to be sent by the matching engine to the credit engine. If not, the method 1400 may iterate back to 1402. If taker orders are causing a credit request message to be sent by the matching engine to the credit engine, at 1404, the method 1400 may include determining whether the canceled-yet-previously-sent queue at the matching engine is empty. If empty, the method 1400 may proceed to 1408. If not empty, at 1406, the method 1400 may include dequeuing identifiers for orders that were successfully canceled and inserting, into the credit request message, as a field that is optional and repeating, and then proceeding to 1408. At 1408, the method 1400 may include sending the credit request message from the matching engine to the credit engine.

### Phantom Orders

A feature of the original disclosure is that it may allow non-blocking credit checking. In an implementation, this may mean that orders received from participants at the matching engine continue to be processed even when credit requests are in-flight, and that additional credit requests can be sent from the matching engine even when previously sent requests remain in-flight. To avoid violations of the venue's price-time priority rules and/or displaying fleetingly crossed markets, it may be necessary to introduce a new logic into the venue's matching engine components and market data components pertaining to ‘phantom orders’.

In this context a so-called phantom order is one that crosses the bid-ask spread (i.e., acts as taker) and has a persistent time-in-force (e.g., is not an immediate-or-cancel or a fill-or-kill order). A phantom order will—according to this new logic, but ostensibly paradoxically—usually both be inserted into the book as a potential maker order, and substantially simultaneously be sent as a taker with its price compatible contra orders in a credit request by the matching engine to the credit engine. When used in conjunction with the Ideal Latency Floor disclosures, draining of a taker batch may cause several competing taker orders to be inserted into the book as phantom orders ‘all-at-once’.

To avoid the display of a fleetingly crossed market in the instrument's book the matching engine may mark such an order as ‘phantom’ e.g., using a Boolean field on the order. Upon insertion into the book by the matching engine may set this field set to ‘true’ on a phantom order, and false on all other orders. Upon receipt of the credit response for the request containing this order as taker from the credit engine, the matching engine may set this field to false (and never subsequently set to true again for this order). The matching engine may transmit to the market data distributor this order with its phantom Boolean field (along with its temporal position id and other fields such as price, open quantity, instrument etc), and subsequently transmit a message to the market data distributor after this field is updated to false due to the received credit response (and any other modified fields as indicated in that response, such as its open quantity). When the field is true on an order that order may not be published by the market data distributor in data sent to participants; when it is set to false it may be eligible for publication.

If a subsequent taker order is processed against book by the matching engine, regardless of the value of the field indicating ‘phantomness’, the order may be considered for inclusion in the computation of price-compatible contra orders thereby ensuring that price-time priority is not violated if the same order is selected as contra while it is also in-flight to credit as a taker order. The credit engine will make use of its cache of the most recent version of orders to ensure this order, if transmitted (say) twice in quick succession (once as taker, and then as maker) this order is not ‘overfilled’.

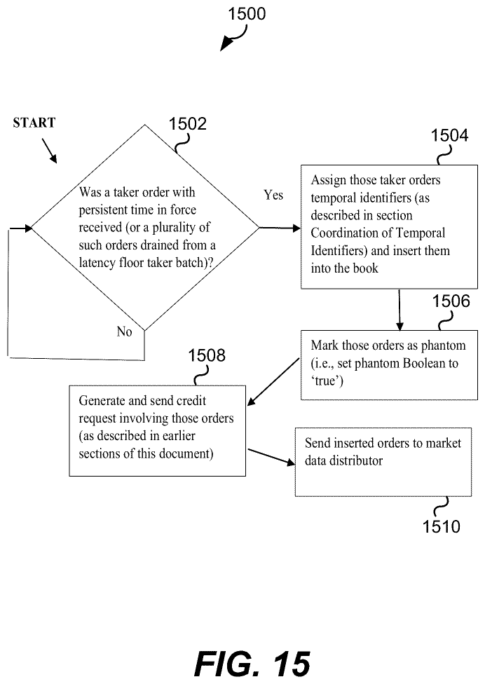

FIG. 15 illustrates an example of a method 1500 for designating phantom orders, according to an implementation. The method 1500 may be executed by a matching engine (such as matching engine 220). At 1502, the method 1500 may include determining whether a taker order with persistent time in force is received (or a plurality of such orders drained from a latency floor taker batch). If not, the method 1500 may iterate back to 1502. If a taker order with persistent time in force is received (or a plurality of such orders drained from a latency floor taker batch), at 1504, the method 1500 may include assigning each such taker order with a respective temporal identifier (such as described with respect to the coordination of temporal identifiers) and inserting them into the book (such as the limit order book 222). At 1506, the method 1500 may include marking those orders as phantom (such as by setting a phantom Boolean to ‘true’ or other stored association to indicate that an order is a phantom order). At 1508, the method 1500 may include generating and sending a credit request involving those orders (such as described at FIG. 8). At 1510, the method 1500 may include sending inserted orders to a market data distributor, which may provide market data updates to market participants (such as market participants 201A-N).

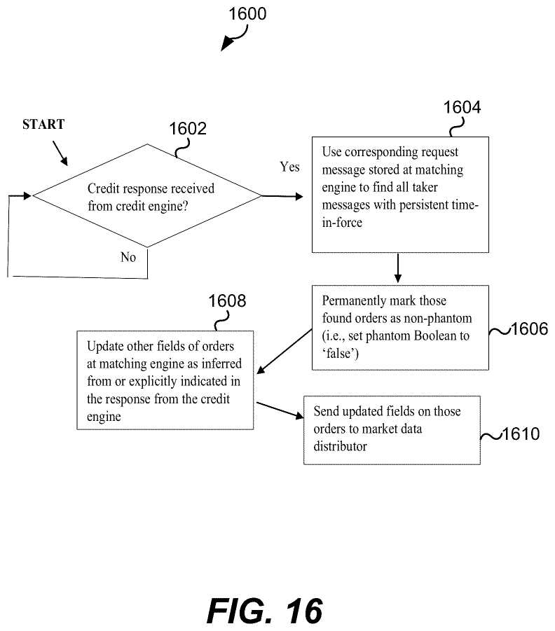

FIG. 16 illustrates an example of a method 1600 for removing designation of an order as ‘phantom’, according to an implementation. The method 1600 may be executed by a matching engine (such as matching engine 220).

At 1602, the method 1600 may include determining whether a credit response is received from the credit engine (such as credit engine 230). At 1604, the method 1600 may include using the corresponding request message stored at the matching engine to find taker messages with persistent time-in-force. At 1606, the method 1600 may include permanently marking found orders as non-phantom (i.e., set phantom Boolean to ‘false’ or other stored association to indicate non-phantom messages). At 1608, the method 1600 may include updating other fields of orders at the matching engine as inferred from or explicitly indicated in the response from the credit engine. At 1612, the method 1600 may include sending updated fields on those orders to a market data distributor.

### Unacks

In an implementation of the disclosures of FIG. 1-7, orders are marked at the matching engine as ‘uncertain’ when they are in-flight to the credit engine. For purposes of ease of auditability, recovery and reconciliation between a request and a corresponding response (and so on) it may instead be preferable to indicate this ‘uncertainness’ by way of a hash set field on the order. Upon the sending of a credit request to the matching engine an integer may be read from a counter and inserted into its message as its ‘credit request id’ (as described earlier in this document). That credit request id may also be added to the hash set field of each of the orders involved in that credit request at the matching engine as that request is sent. We may call this hash set field on the order at the matching engine its ‘unacks’. In an implementation, this field may only be required for orders with a persistent time-in-force.

When its unacks set's size is non-zero the matching engine is uncertain about the order because it is effectively in-flight to or from the credit engine in a credit request or response. This uncertainty arises because it could have been completely filled, partially filled or have been assigned a new temporal identifier by the credit engine, and the matching engine will only learn these things upon receiving responses from the credit engine.

Consistent with the disclosure regarding reconciling responses with requests at the matching engine, upon receipt of a credit response all the orders appearing in the corresponding request may have the credit request id removed from their unacks set by the matching engine. When requests sent by the matching engine to the credit engine are non-blocking, the unacks set size field of an order may grow as large as number of requests in-flight in which it appears as a taker or contra order.

Upon receipt of a cancel request for an order the matching engine may first check the order's unack set size. If it is zero it may process the cancel immediately, removing the order from the book. If, however, the unack set size for the order is non-zero, it may instead mark the order by way of a Boolean field as having a cancel requested. If an order is marked as having a cancel requested the matching engine will prevent it from appearing in the contra order list of any subsequent credit requests. Further, upon the receipt of a credit response the matching engine will determine for any orders marked as having a cancel requested and pertaining to that response whether (i) the order is was completely filled in the response, in which case the cancel will be rejected and order removed from the book, or (ii) whether the unack set size is zero after removing this response's credit request id from it, in which case the cancel request will succeed and the order will be removed from the book.

Where a credit response is received indicating an order has been completely filled the order may be removed from the book regardless of the order's unack set size. Advantageously this ‘eager’ removal (prior to the unacks set size being reduced to zero) may prevent the matching engine sending it in subsequent credit requests as a contra order. It may further ensure the market data distributor can be provided with contemporaneous data about the book than if it were instead only removed after its unacks set size was reduced to zero.

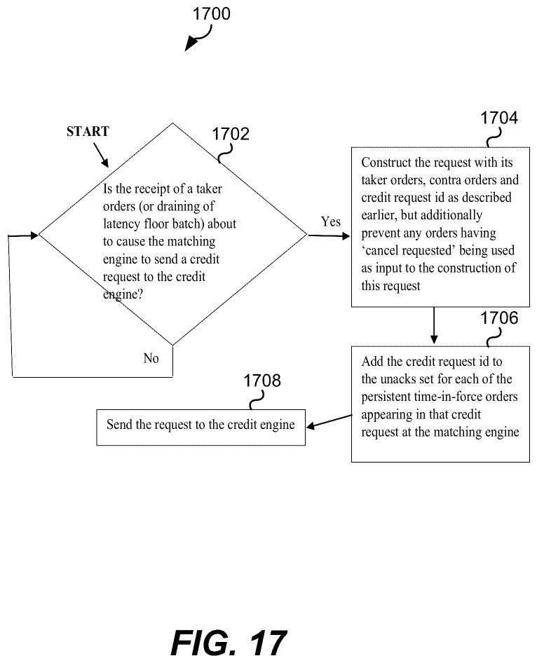

FIG. 17 illustrates an example of a method 1700 for excluding ‘cancel requested’ orders from credit requests and for adding the credit request id to the relevant order's unacks set before the request is sent, according to an implementation. The matching engine 220 may execute the method 1700.

At 1702, the method 1700 may include determining whether receipt of a taker orders (or draining of latency floor batch) will cause the matching engine (such as matching engine 220) to send a credit request to the credit engine (such as credit engine 230). If not, the method 1700 may iterate back to 1702. If receipt of a taker orders (or draining of latency floor batch) will cause the matching engine to send a credit request to the credit engine, at 1704, the method 1700 may include constructing the request with its taker orders, contra orders and credit request ID, but additionally prevent any orders having ‘cancel requested’ being used as input to the construction of this request. At 1706, the method 1700 may include adding the credit request ID to the unacks set for each of the persistent time-in-force orders appearing in that credit request at the matching engine. At 1708, the method 1700 may include sending the request to the credit engine.

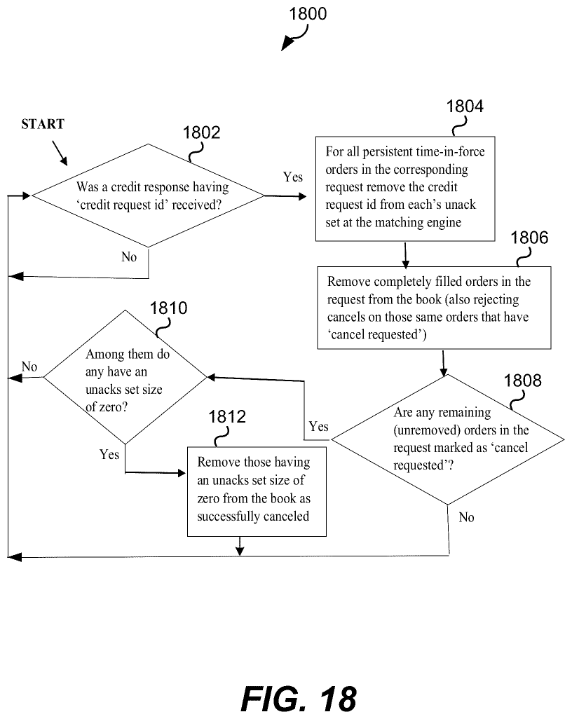

FIG. 18 illustrates an example of a method 1800 for removing from the relevant orders unack sets the credit request id upon receipt of its response, and for handling orders that are completely filled and ones that have ‘cancel requested’ upon receipt of that response, according to an implementation. The matching engine 220 may execute the method 1800.

At 1802, the method 1800 may include determining whether a credit response having a ‘credit request ID’ was received. If not, the method 1800 may iterate back to 1802. If a credit response having a ‘credit request ID’ was received, At 1804, the method 1800 may include, for persistent time-in-force orders in the corresponding request, removing the credit request id from each's unack set at the matching engine. At 1806, the method 1800 may include removing filled orders in the request from the book (and rejecting cancels on those same orders that have ‘cancel requested’). At 1808, the method 1800 may include determining whether any of the orders among them have an unacks set size of zero. If not, the method 1800 may iterate back to 1802. If any of the orders among them have unacks set size of zero, at 1810, the method 1800 may include determining whether any remaining (unremoved) orders in the request marked as ‘cancel requested’ exist. If not, the method 1800 may iterate back to 1802. If any remaining (unremoved) orders in the request marked as ‘cancel requested’ exist, at 1812, the method 1800 may include removing those having an unacks set size of zero from the book as successfully canceled.

### Order Cache at Credit Engine

In an implementation of the disclosures of FIG. 1-7, orders are cached by the credit engine—especially those it modifies as a result of matching them. Advantageously, this may mean that (i) upon receipt of a credit request at the credit engine a contemporaneous version of the order can be obtained from that cache thereby preventing overfills and time-priority violations on that order, and (ii) the matching engine may need only to send an identifier for an order that was previously transmitted to the credit engine (rather than the whole order including all its fields) thereby reducing the request message's size.

The following include techniques for managing that order cache at the credit engine. In an implementation it may be advantageous to assign each order an immutable key at the matching engine that, as described earlier, may constitute the order's instrument and an integer identifier to uniquely identify that order. In this same implementation the credit engine may maintain two separate data structures for its cache of orders. The first data structure may be for orders it has received but not (yet) modified as a result of matching them (call this the ‘unmodified order cache’). The second data structure may be for orders that it has received and has modified as a result of matching them (call this the ‘modified order cache’). In this same implementation only orders with a persistent time-in-force are cached; immediate-or-cancel and fill-or-kill orders need not be cached because they can only be subject to matching once and are never inserted into the book or resent to the credit engine.

The two data structures above may be implemented as hash maps. The key of both these hash maps may be the unique identifier of the order (e.g., the pair of instrument and integer id, stored in an array list of size 2) and the value may be the credit engine's copy of the order object itself.

Upon receipt of a credit request the credit engine may iterate over all complete orders and order keys in the message, in both the taker orders and contra orders. If a complete order has a persistent time-in-force the credit engine may store it in the unmodified order cache, noting that the matching engine will only send a complete order to the credit engine the first time such an order is sent there; any subsequent time that same order is sent from the matching engine to the credit engine the matching engine will ensure only the key for the order is sent. If an order key is encountered the credit engine will use that key to lookup its copy of the order in the modified order cache and unmodified order cache—the order may appear in only one of those two data structures, and not both. If it appears in neither then the credit engine may infer the order has been completely filled or otherwise closed and is no longer eligible for matching and may exclude it from any subsequent computations (e.g., matching, credit checking etc).

Having cached the received orders with persistent time-in-force and retrieved eligible orders from one of the two caches for the order keys, the credit engine may perform the matching operation on those retrieved and new orders. At the conclusion of this matching process for this request, the credit engine may remove orders with persistent time-in-force that have been completely filled as a result of that matching process from both its modified and unmodified order caches. It may further move orders that have been only partially filled from the unmodified order cache (should the order exists there) to the modified order cache.

Relating to piggybacked cancels appearing in the credit request (described earlier in section ‘Piggybacking Canceled Order Information’) the credit engine may iterate over the keys for these canceled orders removing them from the unmodified order cache and modified order cache. The implementation of these piggybacked cancels described earlier may guarantee that the order to which the key refers will appear in exactly one of these two caches at the credit engine, otherwise the key will not be sent.

During the matching process, for each order modified, the credit engine may keep track on a per order basis of only those fields modified by that process for that credit request. It may do so, so only the modified fields are sent back to the matching engine in conjunction with the keys for those orders.

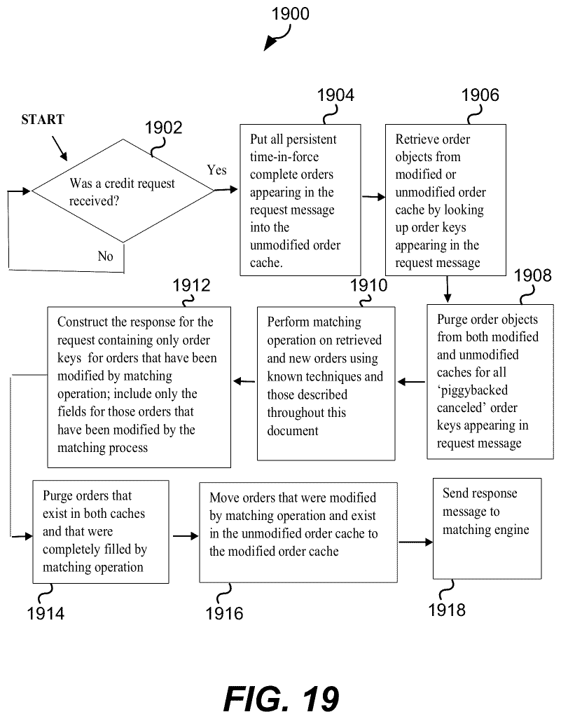

FIG. 19 illustrates an example of a method 1900 for maintaining its credit cache upon receipt of a credit request from the matching engine, according to an implementation. The method 1900 may be executed by a credit engine (such as credit engine 230).

At 1902, the method 1900 may include determining whether a credit request is received. If not, the method 1900 may iterate back to 1902. If a credit request is received, at 1904, the method 1900 may include putting persistent time-in-force complete orders appearing in the request message into the unmodified order cache. At 1906, the method 1900 may include retrieving order objects from the modified or unmodified order cache by looking up order keys appearing in the request message.

At 1908, the method 1900 may include purging order objects from both modified and unmodified caches for all ‘piggybacked canceled’ order keys appearing in request message. At 1910, the method 1900 may include performing a matching operation on retrieved and new orders. Such matching operation may be performed as described herein. At 1912, the method 1900 may include constructing the response for the request containing only order keys for orders that have been modified by matching operation. In some examples, only the fields for those orders that have been modified by the matching process are included.

At 1914, the method 1900 may include purging orders that exist in both caches and that were completely filled by the matching operation. At 1916, the method 1900 may include moving orders that were modified by the matching operation and exist in the unmodified order cache to the modified order cache. At 1918, the method 1900 may include sending a response message to the matching engine.

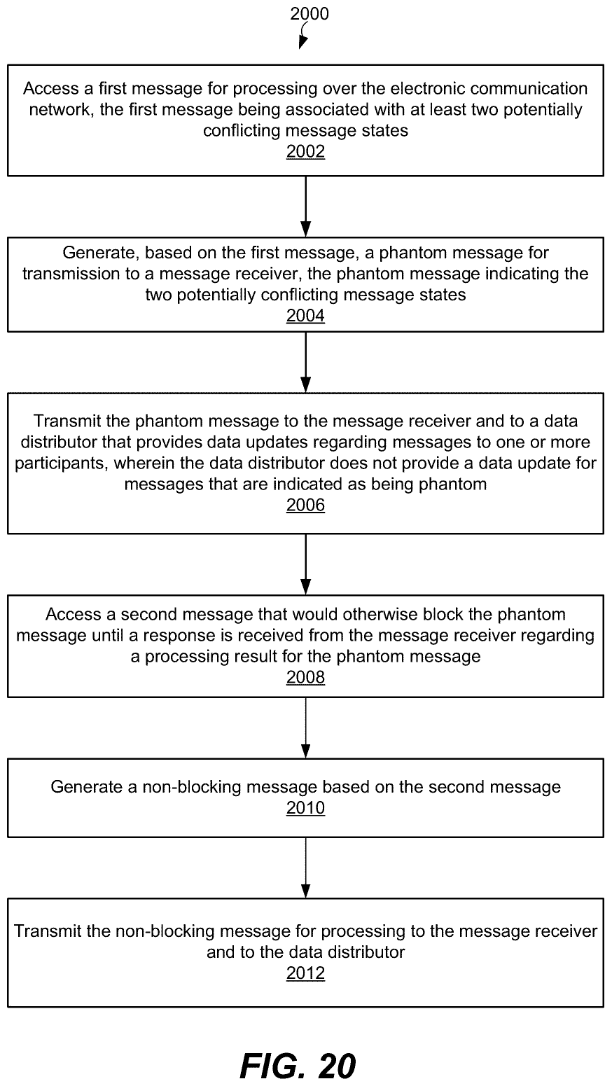

FIG. 20 illustrates an example of a method 2000 for non-blocking phantom message, according to an implementation. At 2002, the method 2000 may include accessing a first message for processing over the electronic communication network, the first message being associated with at least two potentially conflicting message states. To illustrate, for example, the first message may be an order message for trading on an ETV 210. In this example, the order message may take on characteristics of both a maker order and a taker order. At 2004, the method 2000 may include generating, based on the first message, a phantom message for transmission to a message receiver, the phantom message indicating the two potentially conflicting message states.

At 2006, the method 2000 may include transmitting the phantom message to the message receiver and to a data distributor (such as a market data distributor) that provides data updates regarding messages to one or more participants, wherein the data distributor does not provide a data update for messages that are indicated as being phantom. At 2008, the method 2000 may include accessing a second message that would otherwise block the phantom message until a response is received from the message receiver regarding a processing result for the phantom message. At 2010, the method 2000 may include generating a non-blocking message based on the second message. At 2012, the method 2000 may include transmitting the non-blocking message for processing to the message receiver and to the data distributor.

Some of the method 2000 may be performed by a message transmitter, such as the message transmitter 120 and/or matching engine 220 respectively illustrated at FIGS. 1 and 2. Alternatively, or additionally, some of the method 2000 may be performed by a message receiver, such as the message receiver 130 and/or credit engine 230 respectively illustrated at FIGS. 1 and 2. Some or all of the method 2000 may further include at least some of the features or operations described with respect to FIGS. 1-19 and/or 21. For example, the method 2000 may include some or all operations of the message transmitter 120 or matching engine 220 respectively illustrated in FIGS. 1 and 2. Alternatively, or additionally, the method 2000 may include some or all operations of the message receiver 130 or credit engine 230 respectively illustrated in FIGS. 1 and 2. In some examples, the method 2000 may include some or all operations of FIGS. 3-19 and/or 21.

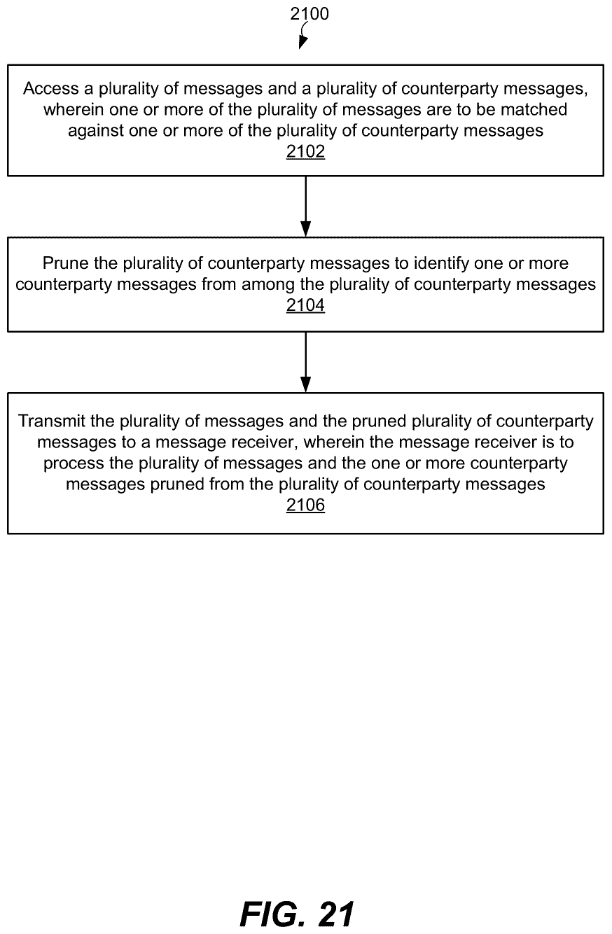

FIG. 21 illustrates an example of a method 2100 for pruning messages prior to transmission, according to an implementation. At 2102, the method 2100 may include accessing a plurality of messages and a plurality of counterparty messages, wherein one or more of the plurality of messages are to be matched against one or more of the plurality of counterparty messages. At 2104, the method 2100 may include pruning the plurality of counterparty messages to identify one or more counterparty messages from among the plurality of counterparty messages. At 2106, the method 2100 may include transmitting the plurality of messages and the pruned plurality of counterparty messages to a message receiver, wherein the message receiver is to process the plurality of messages and the one or more counterparty messages pruned from the plurality of counterparty messages.

Some of the method 2100 may be performed by a message transmitter, such as the message transmitter 120 and/or matching engine 220 respectively illustrated at FIGS. 1 and 2. Alternatively, or additionally, some of the method 2100 may be performed by a message receiver, such as the message receiver 130 and/or credit engine 230 respectively illustrated at FIGS. 1 and 2. Some or all of the method 2100 may further include at least some of the features or operations described with respect to FIGS. 1-20. For example, the method 2100 may include some or all operations of the message transmitter 120 or matching engine 220 respectively illustrated in FIGS. 1 and 2. Alternatively, or additionally, the method 2100 may include some or all operations of the message receiver 130 or credit engine 230 respectively illustrated in FIGS. 1 and 2. In some examples, the method 2100 may include some or all operations of FIGS. 3-20.

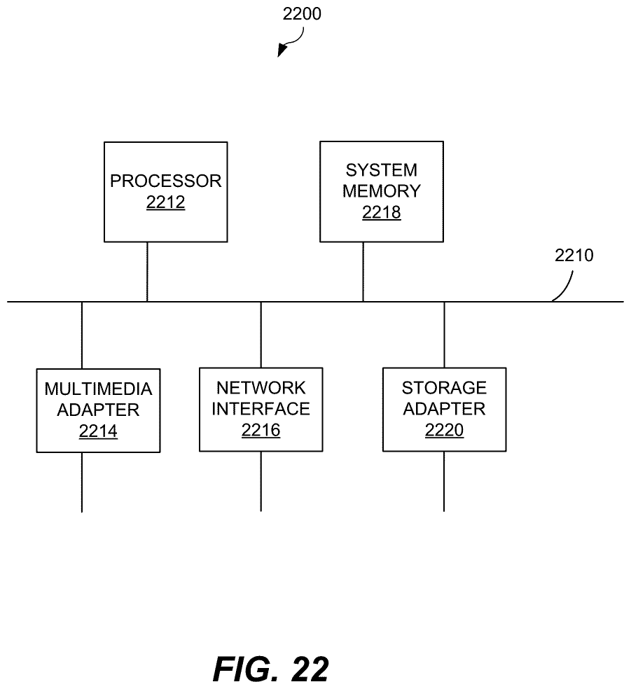

FIG. 22 illustrates an example of a computer system 2200 that may be implemented by the features illustrated in FIG. 1 or 2. The computer system 2200 may include, among other things, an interconnect 2210, a processor 2212, a multimedia adapter 2214, a network interface 2216, a system memory 2218, and a storage adapter 2220.

The interconnect 2210 may interconnect various subsystems, elements, and/or components of the computer system 2200. As shown, the interconnect 2210 may be an abstraction that may represent any one or more separate physical buses, point-to-point connections, or both, connected by appropriate bridges, adapters, or controllers. In some examples, the interconnect 2210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 2210 may allow data communication between the processor 2212 and system memory 2218, which may include read-only memory (ROM) or flash memory (neither shown), random-access memory (RAM), and/or other non-transitory computer readable media (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 2212 may control operations of the computer system 2200. In some examples, the processor 2212 may do so by executing instructions such as software or firmware stored in system memory 2218 or other data via the storage adapter 2220. In some examples, the processor 2212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 2214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 2216 may provide the computer system 2200 with an ability to communicate with a variety of remote devices over a network. The network interface 2216 may include, for example, an Ethernet adapter, a Fibre Channel adapter, and/or other wired-or wireless-enabled adapter. The network interface 2216 may provide a direct or indirect connection from one network element to another, and facilitate communication and between various network elements.

The storage adapter 2220 may connect to a standard computer readable medium for storage and/or retrieval of information, such as a fixed disk drive (internal or external).

Other devices, components, elements, or subsystems (not illustrated) may be connected in a similar manner to the interconnect 2210 or via a network. The network may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

The devices and subsystems can be interconnected in different ways from that shown in FIG. 22. Instructions to implement various examples and implementations described herein may be stored in computer-readable storage media such as one or more of system memory 2218 or other storage. Instructions to implement the present disclosure may also be received via one or more interfaces and stored in memory. The operating system provided on computer system 2200 may be MS-DOS®, MS-WINDOWS®, OS/2®, OS X®, IOS®, ANDROID®, UNIX®, Linux®, or another operating system.

In FIGS. 1A and 1B, as well as in other drawing Figures, different numbers of entities than those depicted may be used. Furthermore, according to various implementations, the components described herein may be implemented in hardware and/or software that configure hardware.

For simplicity and illustrative purposes, the disclosure included descriptions that may refer to examples. In the description, numerous specific details have been set forth in object to provide a thorough understanding of the present disclosure. It will be readily apparent however, that the disclosure may be practiced without limitation to these specific details. In other instances, some methods and structures have not been described in detail so as not to unnecessarily obscure the present disclosure. In some instances, various method operations may be omitted and the various method operations are not necessarily performed in the object in which they are presented.

Throughout the disclosure, the term “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. A system of non-blocking phantom messages to reduce congestion and execution time in an electronic communication network, the system comprising:
a message transmitter programmed to:
access a first message for processing over the electronic communication network, the first message being associated with at least two potentially conflicting message states;
generate, based on the first message, a phantom message for transmission to a message receiver, the phantom message indicating the two potentially conflicting message states;
transmit the phantom message to the message receiver and to a data distributor that provides data updates regarding messages to one or more participants, wherein the data distributor does not provide a data update for messages that are indicated as being phantom;
access a second message that would otherwise block the phantom message until a response is received from the message receiver regarding a processing result for the phantom message;
generate a non-blocking message based on the second message; and
transmit the non-blocking message for processing to the message receiver and to the data distributor.

2. The system of claim 1, wherein the first message comprising a phantom data field that indicates whether or not the first message is to be considered phantom, and wherein to generate the phantom message, the message transmitter is programmed to set the phantom data field to indicate that the first message is phantom.

3. The system of claim 1, wherein the message transmitter is further programmed to:
access a response from the message receiver regarding the phantom message;
update the phantom message to be a non-phantom message; and
transmit the update to the data distributor, which provides a data update for the non-phantom message based on the update.

4. The system of claim 1, wherein the message transmitter is further programmed to:
determine whether or not the first message is to be considered phantom based on one or more characteristics of the first message.

5. The system of claim 1, wherein the message transmitter is further programmed to:
access a plurality of messages and a plurality of counterparty messages, wherein one or more of the plurality of messages are to be matched against one or more of the plurality of counterparty messages;
prune the plurality of counterparty messages to identify one or more counterparty messages from among the plurality of counterparty messages; and
transmit the plurality of messages and the pruned plurality of counterparty messages to a message receiver, wherein the message receiver is to process the plurality of messages and the one or more counterparty messages pruned from the plurality of counterparty messages.

6. The system of claim 5, wherein to prune the plurality of counterparty messages, the message transmitter is further programmed to:
simulate matching between the plurality of counterparty messages and the plurality of messages based on one or more matching criteria, wherein the pruned plurality of counterparty messages is based on the simulated matching.

7. The system of claim 6, wherein to simulate matching, the message transmitter is further programmed to:
simulate matching based on a prioritization of the plurality of counterparty messages.

8. The system of claim 1, wherein the message transmitter is further programmed to:
increment, prior to transmission to the message receiver, a temporal identifier based the phantom message and increment the temporal identifier based on the non-blocking message and any subsequent message, wherein the temporal identifier maintains an ordering of messages received at the message transmitter.

9. The system of claim 1, further comprising the message receiver, the message receiver programmed to:
perform a matching operation on the phantom message and the non-blocking message based on respective one or more characteristics of the phantom message and the non-blocking message.

10. The system of claim 9, wherein the message receiver is programmed to:
transmit a result of the matching operation to the message transmitter.

11. A method of non-blocking phantom messages to reduce congestion and execution time in an electronic communication network, the method comprising:
accessing, by a message transmitter, a first message for processing over the electronic communication network, the first message being associated with at least two potentially conflicting characteristics;
generating, by the message transmitter, based on the first message, a phantom message for transmission to a message receiver, the phantom message indicating the two potentially conflicting message states;
transmitting, by the message transmitter, the phantom message to the message receiver and to a data distributor that provides data updates regarding messages to one or more participants, wherein the data distributor does not provide a data update for messages that are indicated as being phantom;
accessing, by the message transmitter, a second message that would otherwise block the phantom message until a response is received from the message receiver regarding a processing result for the phantom message;
generating, by the message transmitter, a non-blocking message based on the second message; and
transmitting, by the message transmitter, the non-blocking message for processing to the message receiver and to the data distributor.

12. The method of claim 11, wherein the first message comprising a phantom data field that indicates whether or not the first message is to be considered phantom, and wherein to generating the phantom message comprises setting the phantom data field to indicate that the first message is phantom.

13. The method of claim 11, the method further comprising:
accessing a response from the message receiver regarding the phantom message;
updating the phantom message to be a non-phantom message; and
transmitting the update to the data distributor, which provides a data update for the non-phantom message based on the update.

14. The method of claim 11, the method further comprising:
determining whether or not the first message is to be considered phantom based on one or more characteristics of the first message.

15. The method of claim 11, the method further comprising:
accessing a plurality of messages and a plurality of counterparty messages, wherein one or more of the plurality of messages are to be matched against one or more of the plurality of counterparty messages;
pruning the plurality of counterparty messages to identify one or more counterparty messages from among the plurality of counterparty messages; and
transmitting the plurality of messages and the pruned plurality of counterparty messages to a message receiver, wherein the message receiver is to process the plurality of messages and the one or more counterparty messages pruned from the plurality of counterparty messages.

16. The method of claim 15, wherein pruning the plurality of counterparty messages comprises:
simulating matching between the plurality of counterparty messages and the plurality of messages based on one or more matching criteria, wherein the pruned plurality of counterparty messages is based on the simulated matching.

17. The method of claim 16, wherein simulating matching comprises:
simulating matching based on a prioritization of the plurality of counterparty messages.

18. The method of claim 11, the method further comprising:
incrementing, prior to transmission to the message receiver, a temporal identifier based the phantom message and increment the temporal identifier based on the non-blocking message and any subsequent message, wherein the temporal identifier maintains an ordering of messages received at the message transmitter.

19. The method of claim 11, the method further comprising:
performing, by the message receiver, a matching operation on the phantom message and the non-blocking message based on respective one or more characteristics of the phantom message and the non-blocking message.

20. A non-transitory computer readable medium storing instructions that, when executed by a message transmitter, programs the message transmitter to:
access a plurality of messages and a plurality of counterparty messages, wherein one or more of the plurality of messages are to be matched against one or more of the plurality of counterparty messages;
prune the plurality of counterparty messages to identify one or more counterparty messages from among the plurality of counterparty messages; and
transmit the plurality of messages and the pruned plurality of counterparty messages to a message receiver, wherein the message receiver is to process the plurality of messages and the one or more counterparty messages pruned from the plurality of counterparty messages.
